(19) United States
(12) Patent Application Publication
(10) Pub. No.: US 2025/0372700 A1
(43) Pub. Date: Dec. 4, 2025

(54) SOLID-STATE BATTERIES WITH GLASSY SOLID ELECTROLYTE

(71) Applicant: PolyPlus Battery Company, Berkeley, CA (US)

(72) Inventors: Steven J. Visco, Berkeley, CA (US); Vitaliy Nimon, Berkeley, CA (US); Alexei Petrov, Berkeley, CA (US); Yevgeniy S. Nimon, Berkeley, CA (US); Bruce D. Katz, Berkeley, CA (US)

(21) Appl. No.: 19/092,848

(22) Filed: Mar. 27, 2025

Related U.S. Application Data
(60) Provisional application No. 63/652,567, filed on May 28, 2024.

(51) Int. Cl. H01M 10/0562; H01M 10/0525

(52) U.S. Cl. CPC H01M 10/0562; H01M 10/0525; H01M 2300/0068; H01M 2300/0094

(57) ABSTRACT

A solid-state battery having an enveloped electrode assembly includes an electroactive layer having a first major surface and side surfaces that are encapsulated within a Li ion conductive glassy medium. The encapsulated electroactive layer may be in compression.

### STATEMENT OF GOVERNMENT SUPPORT

This invention was made with Government support under Cooperative Agreement Award No.: HQ0034-20-2-0007 awarded by the U.S. Department of Defense. The Government has certain rights in this invention.

### CROSS-REFERENCE TO RELATED APPLICATIONS

An Application Data Sheet is filed concurrently with this specification as part of the present application. Any application that the present application claims benefit of or priority to as identified in the concurrently filed Application Data Sheet is incorporated by reference herein in its entirety and for all purposes.

### BACKGROUND

### Field and Related Art

This disclosure relates to battery cells and battery cell components and fabrication techniques therefor, and in particular to glassy embedded electrode assemblies, and solid-state battery cells incorporating such assemblies, and methods of their fabrication. In particular embodiments, it pertains to solid-state batteries (e.g., fully solid-state) that require minimal or no stacking pressure while achieving an extended cycle life.

Solid state battery cells are generally based on a solid electrolyte sandwiched between two electrodes, often involving a material layup composed of discretely fabricated component layers in a stacked or wound construction. While battery technology has substantially advanced in recent years, there remains demand for enhanced power output, reduced charging time and improved cycle life.

### SUMMARY

The present disclosure provides glassy embedded solid-state electrode assemblies that support ampere-hour capacity and solid-state electrode separation when incorporated in a solid-state battery cell of the present disclosure and methods for their fabrication. In accordance with embodiments of the present disclosure, the glassy embedded solid-state electrode assembly i) supports high areal ampere-hour capacity in the solid-state, ii) enables minimization of non-active material for high energy density performance, and iii) provides ionically conductive solid-state separation in a battery cell between the electrode assembly, serving as a first electrode (e.g., the positive electrode), and a second electrode (e.g., the negative electrode).

In accordance with embodiments of the present invention, a glassy embedded electrode assembly is composed of a positive and/or negative electroactive network (e.g., an electroactive layer) that is embedded with and/or within a continuous glassy medium including a Li ion conducting glass (e.g., the medium is a Li ion conducting sulfide glass layer). In particular embodiments the embedded architecture of the assembly is formed and configured to achieve a mechanically resilient state designed to maintain the structural stability of the electroactive layer during cycling, thereby minimizing the need for significant stack pressure on the battery cells where the glassy embedded electrode assembly is utilized.

In various embodiments, the glassy embedded electrode assembly structure of the present disclosure includes a composite material structure composed of first and second interpenetrating material components, wherein the first component is a porous solid electroactive network and the second component is a continuous Li ion conductive glassy sulfide medium that encapsulates the electroactive network on a first major surface to form a glassy cover region that extends into the depth of the network, thus forming a three-dimensional (3-D) solid-state interface that is sufficiently robust, stable, and Li ion transparent to enable the fabrication of high performing lithium solid-state battery cells.

In various embodiments, the glassy embedded solid-state electrode assembly is intended for use in a solid-state Li metal battery cell, and in certain embodiments thereof the glassy cover region is substantially devoid of crystalline particles (i.e., crystallites) that are not suitably conductive to Li ions (i.e., have Li ion conducting <10⁻⁸ S/cm), and in some embodiments the glassy cover region is substantially devoid of any crystallites or crystalline particles.

In various embodiments, the glassy embedded electrode assembly has an enveloped structure (sometimes referred to herein as an enveloped electrode assembly), in which the first major surface of the electroactive layer, as well as the edges of the layer along its thickness direction, are structurally contained within the glassy medium, (i.e., wherein the glassy cover region also encapsulates the edges of the electroactive layer). In various embodiments, this configuration physically stabilizes the electroactive layer and its component materials in an operably compressive mechanical state, ensuring intimate contact between the material components during cycling. This maintained contact preserves the structural integrity of the electroactive layer, enabling improved cycling performance with minimal or no externally applied stacking pressure. In some embodiments, the glassy cover region penetrates into the pores of the electroactive layer, yielding an interpenetrating assembly. In other embodiments, the assembly may be configured such that the electroactive layer is enveloped by and contained within the glassy cover region without the glassy medium penetrating the pores of the electroactive layer, or at least without the glassy medium significantly penetrating into the depth of the pores (e.g., only superficially or incidentally).

In various embodiments the glassy embedded electrode assemblies of the present disclosure comprise a composite material structure with an interpenetrating material architecture of a Li ion conductive glassy sulfide medium that embeds and encapsulates a porous solid electroactive network. As its name suggests, the solid electroactive network (or more simply “electroactive network”) is composed of solid electroactive material (e.g., cathode active material) that undergoes electrochemical oxidation and reduction during battery cell charge and discharge, respectively (and vice-versa when the electroactive material is anode active material). Generally, by non-limiting example, for a positive glassy embedded electrode assembly of the present disclosure, the solid cathode active material typically has a potential ≥2 V vs. Li/Li⁺ and for a negative electrode assembly, the solid anode active material typically has a potential ≤1.5 V Li/Li⁺.

In various embodiments the surface(s) of the electroactive material and/or that of the electroactive network is protected by a thin layer (e.g., a nanofilm) that mitigates, and even prevents, adverse reaction between the glassy medium and the electroactive material of the network. For example, the electroactive network, including its interior pore surfaces, may be conformally coated by one or more protective thin layers using non-limiting methods such as sol-gel, solution coating or chemical vapor deposition techniques (e.g., atomic layer deposition, ALD), prior to embedding the network with Li ion conducting sulfide glass. For example, the network surfaces may be coated with a lithium metal oxide protective thin layer (e.g., LiNbO₃, Li₄Ti₅O₁₂, Li₂SiO₃, LiAlO₂, Li₂ZrO₃, Li₂MoO₄, LiInO₂, LiWO₃, Li₂WO₄, Li₂Ti₅O₁₂, LiTaO₃), or a non-lithiated oxide protective thin layer (e.g., a metal or metal oxide of titanium, aluminum, zirconium, niobium, silicon, tantalum, tungsten or some combination thereof), or a sulfide protective thin film (e.g., a metal sulfide or the like, such as nickel sulfide, cobalt sulfide and combinations thereof such as nickel cobalt sulfides, and lithiated varieties such as lithium nickel sulfide or lithium cobalt sulfide or lithium nickel cobalt sulfides). The protective thin layer may be particularly useful for mitigating or preventing adverse reactions when a high temperature approach is used for glassy embedding the electroactive network, especially when process temperatures are near or about the melting or liquidus temperature of the Li ion conducting sulfide glass. In particular embodiments, the glassy embedded electrode assembly is fabricated in a manner that solid-state interfaces are devoid of reaction products resulting from Li ion conducting sulfide glass chemically reacting (e.g., oxidized) in direct contact with electroactive material of the network. For example, sulfidation of the electroactive material is generally mitigated or prevented, as disclosed herein, by using low temperature glassy embedding processes combined with a protective layer/nanofilm. Thickness of the protective layer may be varied depending on its composition. In various embodiments the protective layer is a nanofilm less than 1 micron thick, and typically less than 200 nm thick, or less than 100 nm thick, or less than 50 nm thick, or less than 20 nm thick, or less than 10 nm thick, or less than 5 nm thick, or about 1 nm thick, or less than 1 nm thick. Such a film is oftentimes referred to herein as a protective nanofilm (or more simply as nanofilm).

In accordance with various embodiments of the present disclosure, the two major interpenetrating material components of the glassy embedded electrode assembly are the Li ion conducting glassy sulfide medium and the porous electroactive network. It should be apparent to one of ordinary skill in the art that when referring to the electroactive network as porous, it is not meant to infer that it is porous as an interpenetrating component of the instant electrode assembly, but rather that the network is formed or prefabricated with pores/voids that are subsequently filled, fully or partially, with glassy sulfide media upon manufacturing the embedded assembly. For instance, in various embodiments, when the network pores/voids are completely filled, the glassy embedded solid-state electrode assembly is a substantially dense structure. In other embodiments, the electroactive layer may be a substantially or fully dense preformed layer that is enveloped within and therein constrained by the glassy medium.

A variety of porous electroactive networks are contemplated for use herein. In various embodiments the electroactive network is a discrete porous solid body that is preformed prior to fabricating the electrode assembly, and therewith may be considered herein as an intermediate product in accordance with manufacturing methods for making an electrode assembly of the present disclosure. Generally, such a preformed and porous electroactive network is fabricated as an intermediate product in the absence of glassy sulfide media or Li ion conducting sulfide media generally. In particular embodiments the porous and preformed electroactive network is a porous electroactive monolith (e.g., a freestanding sheet or membrane) or monolithic electroactive layer by which the term monolith or monolithic means a continuous mass of electroactive material in the absence of glassy sulfide media, as opposed to a porous layer or coating that is composed of discrete electroactive material particles held together by a binder material (e.g., an organic binder or an inorganic binder). In various embodiments the preformed and porous electroactive monolith is exemplified in the form of a partially sintered construct of electroactive material (e.g., cathode active material of the intercalating type) that may be formed by compacting cathode active material particles (into a compact or green tape) and heating the compact or green tape to remove any binders and to bring about densification or partial densification by sintering.

In other embodiments the preformed electroactive network is a discrete porous solid body that is not monolithic, but rather a composite material of discrete electroactive particles held together by a binder material that is thermally stable for its utility as a binder when heated to the glass transition temperature T_{g} of the glassy sulfide medium or slightly above, and the binder may be stable at 200° C., 250° C., 300° C., 350° C. and even thermally stable when heated to 400° C. Examples of such a discrete porous solid body include slurry coatings of electroactive particles and a thermally stable binder dispersed in a carrier solvent that may be fabricated as freestanding sheets or more commonly as a coating on a current collecting substrate. In other embodiments it is contemplated that the composite solid body is formed using dry coating process. For instance, the electroactive particles and binder may be formed into a mixture that may be extruded into a porous cathode sheet.

In yet other embodiments the electroactive network is not a discrete preformed body but a contiguous assemblage of electroactive particles that materializes in combination with glassy sulfide media as a result of forming a composite construct therefrom. For example, such a composite construct may be formed by pressing and heating (e.g., via hot isostatic pressing) a mixture of electroactive material particles and Li ion conductive glassy sulfide media (e.g., particles) in a manner that forms the electroactive network and the continuous Li ion conductive glassy medium as interpenetrating components, and in some embodiments effectuates an encapsulating glassy cover region on a first major surface of the composite structure. Other methods of forming the composite construct include extruding the mixture, and in particular extruding the mixture at a temperature of T_{g} of the glass.

In various embodiments the glassy embedded electrode assembly structure of the present disclosure is substantially fully dense, and in other embodiments the structure is not fully dense and has a void microstructure defined in part by the shape of the empty pores and their tortuosity throughout the assembly structure. In a fully dense embodiment, the electrode assembly structure may be wholly inorganic, entirely devoid of organic material. For instance, a wholly inorganic and substantially fully dense glassy embedded electrode assembly structure. When not fully dense, liquid or gel electrolyte may be impregnated into the voids when making a battery cell (e.g., with a hybrid architecture), wherein liquid electrolyte contacts only one electrode (e.g., the positive electrode). In such embodiments, the present disclosure provides a hybrid battery cell with a sealed electrode assembly having a construction that prevents outward seepage of the liquid phase component. In a specific embodiment, the liquid phase electrolyte is retained inside a solid polymer phase as a gel electrolyte. In various embodiments the method for making the sealed electrode assembly includes impregnating the glassy embedded electrode assembly structure with a liquid phase comprising a liquid electrolyte and a light or thermally polymerizable monomer that is activated for polymerization after it has been impregnated into the pores of the electrode assembly structure.

Typically, the electrode assembly includes a current collecting layer adjacent to and in direct touching contacting with the electroactive network (e.g., electroactive layer). The composition of the current collecting layer depends on the electroactive material (e.g., copper or aluminum for a negative or positive electrode structure, respectively). In various embodiments the current collecting layer is deposited as a thin film (e.g., of 1-5 um thickness) onto the second major surface of the electrode assembly structure, opposing the glassy encapsulating first major surface. In other embodiments the electroactive layer is formed or otherwise disposed onto the surface of the current collecting layer (e.g., as a coating or pressed onto a freestanding collector, such as Al foil or Cu foil).

In various embodiments the glassy embedded electrode assembly is monopolar and serves as a positive electrode in a battery cell, and therefore is sometimes referred to herein as a glassy embedded positive electrode assembly (or more simply as a positive electrode assembly). In other embodiments the glassy embedded electrode assembly is a monopolar negative electrode assembly and is incorporated a battery cell to serve as a negative electrode. In yet other embodiments the glassy embedded electrode assembly has a bipolar construction that provides both negative and positive electrode function, with significant benefit in terms of minimizing inactive material weights and volumes. By use of the term monopolar it is meant that the electrode has the same polarity on both sides of the current collector. Whereas a bipolar electrode has active material of different polarities on opposing current collector surface. In another aspect the present disclosure provides battery cells, especially solid-state battery cells, that include a glassy embedded electrode assembly that serves as the positive or negative electrode in the cell, and the glassy cover region of the electrode assembly provides an effective solid-state Li ion conducting separator that prevents direct contact between the electroactive network (e.g., a monolith of cathode active material) and the other electrode in the cell (e.g., a negative electrode such as, or comprising, Li metal). In other embodiments, the present disclosure provides a battery cell having a hybrid construction. For instance, a sealed glassy embedded electrode assembly that includes a liquid or gel phase electrolyte in its pores, and a lithium metal layer opposing the glassy cover region of the sealed assembly. In some embodiments, the as-fabricated battery cell may be devoid of lithium metal until it is plated onto the current collector during initial charging of the cell. In yet other embodiments, the glassy embedded electrode assembly structure (e.g., positive electrode assembly structure) may be combined with a solid-state electrolyte separator layer disposed between it (the assembly structure) and the negative electrode (e.g., a layer of lithium metal). For instance, the solid-state electrolyte separator disposed in direct contact with the glassy cover region and a lithium metal layer disposed on the opposite surface of the solid-state electrolyte separator.

In particular embodiments the solid-state electrolyte separator layer may be a dense layer of lithium ion conducting sulfide glass less than 100 um thick, or not greater than 50 um thick, or not greater than 30 um thick, or not greater than 20 um thick, or not greater than 15 um or 10 um thick. In an alternative embodiment, the solid-state electrolyte separator layer may not be a sulfide glass, it may be a thin Li ion conducting layer of an oxide or phosphate (e.g., a thin layer of a LiPON or LiPON like glass). And yet in other embodiments the solid-state electrolyte separator layer may be a dense layer of an oxide or phosphate Li ion conducting solid electrolyte. For instance the oxide/phosphate a lithium titanium phosphate, such as LATP having stoichiometry Li₁₊ₓAlₓTi₂₋ₓ(PO₄)₃ or perovskite and the like. In other embodiments the oxide electrolyte is a garnet layer (e.g., LLZO) as is known in the battery arts, and in some instances has compositions Li₇La₃Zr₂O₁₂.

In other embodiments the solid electrolyte separator layer may be a glass or glass ceramic or full ceramic of the garnet type that is fabricated initially as a glass sheet. In various embodiments the glass may be processed from a Ta doped Li₇La₃Zr₂O₁₂ material using glass forming dopants (e.g., by melt quenching and then drawing the glass into the ribbon). The ribbon so formed may be used as a dense solid electrolyte layer if sufficiently conductive, or otherwise heat treated to crystallize a more conductive phase. Glass forming additives may include oxides (e.g., tantalum oxide, or germanium oxide, or gallium oxide, or lanthanum oxide, or silicon oxide, or boron oxide, or chromium oxide, or indium oxide, or bismuth oxide, or vanadium oxide, or phosphorus oxide). For instance, in a particular embodiment the composition of the melt may be composed of lithium, lanthanum, zirconium and oxygen, and tantalum oxide may be the glass forming additive. Moreover, various percentages of glass/crystalline wt. % are contemplated, including about 95% crystalline and 5% glassy, or about 90% crystalline and 10% glassy, or about 80% crystalline and 20% glassy, or about 70% crystalline and 30% glassy, or about 60% crystalline and 40% glassy, or about 50% crystalline and about 50% glassy.

In some embodiments the dense layer is an oxide/phosphate such as lithium titanium phosphate (LATP) or the like having a thin interlayer/film disposed between it and the lithium metal. For instance, the LATP having a thin film of a garnet-like material deposited on its surface. In a particular embodiment the interlayer film may be an amorphous oxide layer that is formed by physical/chemical vapor deposition (e.g., sputtering or the like), wherein the sputtering target has composition Li_{7+x-y}AₓB₃₋ₓC_{2-y}D_{y}O₁₂ wherein A is a bivalent cation, B is a trivalent cation, C is a tetravalent cation, and D a pentavalent cation, with 0≤x<3 (e.g., 0≤x≤2 or 0≤x<1). In particular embodiment the target is a Ta doped LLZO. The surface film so formed may be amorphous with Li ion conductivity of at least 10⁻⁷ S/cm, or at least 10⁻⁶ S/cm, or at least 10⁻⁵ S/cm. In accordance with the present disclosure the nature of the surface film is sufficiently robust that it protects grain boundaries of the bulk membrane (e.g., that of the LATP) and thereby allows for reversible cycling of lithium metal. In other embodiments the bulk membrane may be composed of a similar or the same family as the amorphous layer. For instance, the sputtering target and the membrane have a bulk composition Li_{7+x-y}AₓB₃₋ₓC_{2-y}D_{y}O₁₂ wherein A is a bivalent cation, B is a trivalent cation, C is a tetravalent cation, and D a pentavalent cation, with 0≤x<3 (e.g., 0≤y<2 or 0≤x<1). The sputtering target and membrane bulk may have substantially the same composition, or different. It is also contemplated that the bulk membrane may be a lithium ion conducting sulfide material and in particular lithium ion conducting sulfide glass as described herein and in U.S. Pat. No. 10,164,289.

In yet other aspects the present disclosure provides methods, including methods for making a glassy embedded solid-state electrode assembly, and methods for making a fully solid-state electrode assembly and methods for making a sealed electrode assembly containing a liquid phase, and methods for making a battery cell, including methods for making a fully solid-state battery cell and methods for making a hybrid battery cell composed of a liquid or gel containing sealed electrode assembly.

In various embodiments the method for making a glassy embedded electrode assembly structure involves providing or making a preformed porous solid electroactive network and embedding the pores of the network with sulfide glass solid electrolyte in a manner that forms a continuous medium of Li ion conducting glass (i.e., a glassy sulfide medium). In some embodiments the embedding method includes a high temperature process that involves heating the glass to its melting temperature or liquidus temperature and allowing or causing the molten glass to flow into the pores of the network as a hot molten/fluid (e.g., taking advantage of capillary forces), followed by cooling and solidifying the hot glass once it has been fully accommodated inside the pores. In various embodiments a low temperature embedding method is used, as disclosed herein. In particular, a low temperature approach can involve impregnating Li ion conducting sulfide glass particles into pores of the electroactive network to form what is termed herein a “glassy electroactive prepreg.” In various embodiments the prepreg is formed at or about room temperature, or at a temperature that is no greater than 100° C., or no greater than 60° C., or no greater than 40° C. For instance, the glassy electroactive prepreg may be formed by impregnating the pores of the electroactive network with a mixture of sulfide glass particles dispersed in a liquid carrier (e.g., a slurry as such). Once impregnated, the “prepreg” is heated to a temperature at which the Li ion conducting sulfide glass particles viscously sinter. In embodiments, the heated prepreg can wet the network pore surfaces to form a continuous glassy medium interpenetrating with the electroactive network. The viscous sintering temperature can be at or only slightly greater than Tg and below Tc (glass crystallization temperature) of the Li ion conducting glass. For example, the viscous sintering can take place at a temperature that is above Tg and below Tc by at least 20° C., or below Tc by at least 30° C., or below by at least 40° C., or below by at least 50° C.; or below Tc and no more than 20° C. above Tg, or no more than 40° C. above Tg, or no more than 60° C. above Tg, or below Tc and no more than 80° C. above Tg. In other embodiments interior pores and surfaces of the electroactive network may be impregnated and coated using a solution coating method that involves impregnating the porous network with a solution of lithium ion conducting sulfide material dissolved in dissolving solvent (e.g., NMF), and then evaporating the solvent (e.g., with an applied amount of low heat).

In various embodiments, suitable sulfide glass particles can be prepared by milling sulfide glass powders ground at subzero temperatures, such as cryogenic temperatures (e.g., by cryo-grinding or cryo-milling) to prevent plastic deformation during grinding and produce micron and sub-micron powders.

According to various embodiments, an electrode assembly includes an inorganic-organic hybrid solid-state electrode having a composite material structure composed of a continuous inorganic electroactive material structure in the form of an inorganic three-dimensional porous electroactive scaffold and an organic based active metal ion conductive component disposed inside the porous scaffold, the organic component composed of an organic active metal ion conducting material.

In various embodiments, the assembly may include a solid-state electrolyte layer component that is wholly inorganic, substantially dense and pinhole free and an interlayer stabilizing the solid-state electrolyte for contact with electrode.

### BRIEF DESCRIPTION OF THE DRAWINGS

FIGS. 1A-B illustrate an electrode assembly structure that is monopolar and single-sided, having asymmetric opposing major surfaces with associated surface compositions that are materially different, in accordance with various embodiments.

FIGS. 2A-B illustrate a double-sided glassy embedded electrode assembly, in accordance with various embodiments.

FIGS. 3A-D illustrate in cross sectional depiction single-sided asymmetric glassy embedded solid-state electrode assembly structures, in accordance with various embodiments of the present disclosure.

FIG. 4 illustrates a glassy embedded electrode assembly in top view from the perspective of looking directly at a major surface through a glassy cover region, revealing a boundary with electroactive network, in accordance with various embodiments.

FIG. 5 illustrates a single-sided glassy embedded electrode assembly, in accordance with various embodiments.

FIG. 6 illustrates a double-sided electrode assembly in cross-sectional depiction, in accordance with various embodiments of the present disclosure.

FIG. 7 illustrates a porous electroactive monolith, an intermediate component in its preformed state prior to being glassy embedded in accordance with various embodiments.

FIG. 8 illustrates a nanofilm protected porous electroactive network, in accordance with various embodiments of the present disclosure.

FIG. 9 illustrates a glassy embedded electrode assembly including a glassy continuous sulfide medium embedded into the depth of a nanofilm protected monolith, in accordance with various embodiments of the present disclosure.

FIG. 10 illustrates a method involving heating a Li-sulfide glass sheet above T_{g} and pressing it against an electroactive monolith with a pressure sufficient to extrude glass into the pores of the monolith, in accordance with various embodiments of the present disclosure.

FIG. 11 illustrates a casting method involving heating glass in a crucible to a high temperature sufficient to reduce the glass viscosity to a level for which it will readily flow and infuse into the pores of a monolith, in accordance with various embodiments of the present disclosure.

FIG. 12 illustrates a method involving a low temperature approach for making glassy electroactive prepreg at low temperature involving vacuum impregnation of a liquid phase dispersion of Li-sulfide glass particles in a volatile carrier solvent and evaporating the carrier solvent with low to moderate heat, in accordance with various embodiments of the present disclosure.

FIG. 12A illustrates a method for making a glassy electroactive prepreg and glassy embedded electrode assembly, in accordance with various embodiments of the present disclosure.

FIG. 13 illustrates another method involving a low temperature approach for making glassy electroactive prepreg at low temperature involving applying glassy sulfide media particles as a thin layer onto the monolith major surface (e.g., by spraying a glass particle slurry) followed by viscous sintering of the applied glass particle layer, thus forming encapsulating glassy cover region, in accordance with various embodiments of the present disclosure.

FIG. 13A illustrates another method for making a glassy electroactive prepreg and glassy embedded electrode assembly that involves subzero processing of the glassy sulfide media, in accordance with various embodiments of the present disclosure.

FIG. 14A illustrates an alternative glassy embedded electrode assembly having a preformed electroactive network layer that is a slurry coated layer of discrete electroactive particles conjoined by binder and formed on current collector layer, in accordance with various embodiments of the present disclosure.

FIG. 14B illustrates a glassy embedded electrode assembly having a dual electroactive layer in accordance with embodiments of the present disclosure.

FIG. 14C illustrates a glassy enveloped electrode assembly in accordance with embodiments of the present disclosure.

FIG. 14D illustrates an alternative glassy enveloped electrode assembly in accordance with embodiments of the present disclosure.

FIG. 15 illustrates a glassy embedded electrode assembly wherein an electroactive network is formed in-situ along with a glassy medium, in accordance with various embodiments of the present disclosure.

FIG. 16 illustrates a fully solid-state Li metal battery cell in accordance with various embodiments.

FIG. 17 illustrates a fully solid-state Li metal battery cell in accordance with various embodiments including a solid-state electrolyte separator.

FIG. 18 illustrates an inorganic/organic hybrid solid-state electrode in accordance with various embodiments.

FIG. 19 illustrates an inorganic/organic hybrid solid-state electrode in accordance with a particular embodiment wherein the surface is defined by a composite organic component.

FIG. 20 illustrates a solid-state battery cell in accordance with various embodiments.

FIG. 21 illustrates an embodiment of a solid electrolyte structure including an interlayer disposed between a conformal ALD LiPON layer and a lithium metal layer in accordance with a particular embodiment.

### DETAILED DESCRIPTION

Reference will now be made in detail to specific embodiments of the disclosure. Examples of the specific embodiments are illustrated in the accompanying drawings. While the disclosure will be described in conjunction with these specific embodiments, it will be understood that it is not intended to limit the disclosure to such specific embodiments. On the contrary, it is intended to cover alternatives, modifications, and equivalents as may be included within the spirit and scope of the disclosure as defined by the appended claims. In the following description, numerous specific details are set forth in order to provide a thorough understanding of the present disclosure. Embodiments of the present disclosure may be practiced without some or all of these specific details. In other instances, well known process operations have not been described in detail in order not to unnecessarily obscure the present disclosure.

When used in combination with “comprising,” “a method comprising,” “a device comprising” or similar language in this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

In one aspect, the present disclosure is directed to a glassy embedded solid-state electrode assembly structure that provides electrode, separator and electrolyte functionality in a battery cell in which it is incorporated. In various embodiments the electrode functionality of the assembly structure is monopolar. For instance, the glassy embedded solid-state electrode assembly structure is a positive electrode structure having a solid electroactive material network that is composed of cathode active material (CAM), and thus the structure intended for use in a positive electrode assembly. In other embodiments the glassy embedded solid-state electrode assembly structure is a negative electrode structure having a solid electroactive material network that is composed of anode active material (AAM) and intended for use in a negative electrode assembly. In various embodiments, the glassy embedded electrode assembly structure has a single-sided architecture; for instance, a single-sided positive electrode assembly structure or a single-sided negative electrode assembly structure. In other embodiments the electrode structure is monopolar and double-sided. For instance, a double-sided positive electrode assembly structure or a double-sided negative electrode assembly structure. In various embodiments the double-sided electrode assembly structure is substantially symmetric and may be composed of a pair of opposing first and second single-sided structures. Asymmetric double-sided electrode assembly structures are also contemplated, including a bipolar double-sided glassy embedded solid-state electrode assembly structure composed of a first positive electrode assembly structure and a second negative electrode assembly structure.

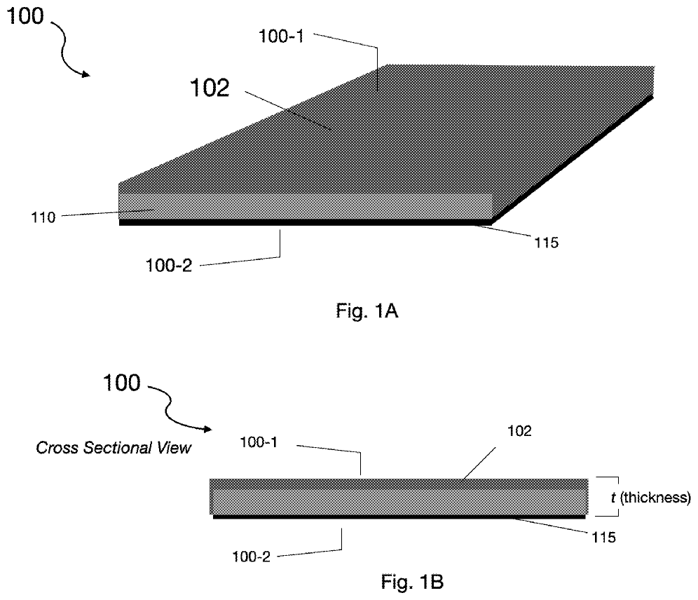

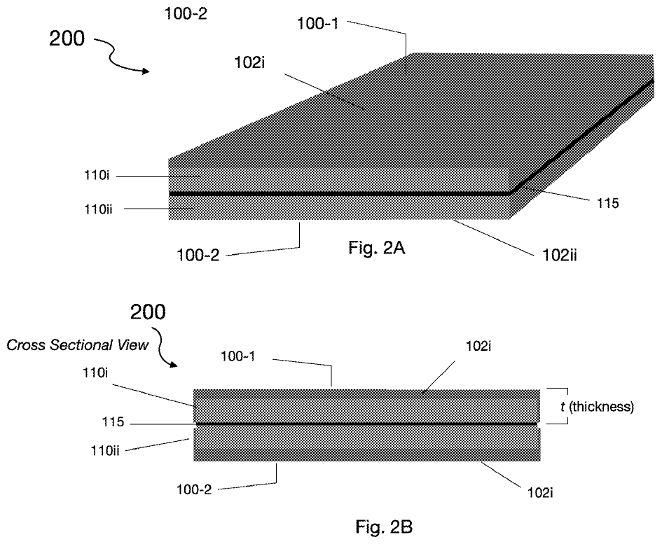

FIGS. 1A-B and FIGS. 2A-B illustrate high level depictions of a single and double-sided solid-state glassy embedded electrode assembly in context prior to its incorporation in a battery cell, and in accordance with various embodiments of the present disclosure.

In FIGS. 1A-B, single sided electrode assembly structure 100, having first and second major opposing surfaces 100-1/100-2, is composed of porous solid electroactive network 110 and inorganic glassy sulfide electrolyte medium 102. Network 110 is a body composed of electroactive material (e.g., a layer or sheet). Glassy medium 102 is a continuous medium of Li ion conducting sulfide glass. Glassy medium 102 encapsulates a first surface of the network and embeds into its depth (not shown) to form a continuous three-dimensional solid-state interface in direct contact with interior surfaces of the network. Network 110 is electroactive and provides ampere-hour capacity for the assembly. Glassy medium 102 is ionically conductive and supports uniform Li ion migration throughout the structure. In FIGS. 2A-B, double sided electrode assembly structure 200 is essentially a pair of single-sided structures stacked in a back-to-back fashion.

In various embodiments glassy embedded solid-state electrode assembly structures 100/200 may be incorporated in a battery cell as fully solid-state structures, and in embodiments thereof the structures may be wholly composed of inorganic materials. In other embodiments, the electrode assembly structure is fabricated for use as a hybrid construct that allows liquid electrolyte and/or a gel electrolyte to penetrate voids that are not filled by the glassy medium during battery cell assembly.

Structures 100/200 are generally layer-like, such as a flat sheet, having first and second major opposing surfaces 100-1/100-2 and a total thickness (t) that is significantly less than the apparent area of either the first or second major surface. Thickness is a tightly controlled parameter and depends in part on the desired aerial capacity (i.e., ampere-hour capacity per unit area) of the structure. Oftentimes thickness will be chosen as a tradeoff between battery rate capability (i.e., power density) and battery energy density (i.e., energy per unit weight or volume). Single sided glassy embedded electrode assembly structures generally have a thickness in the range of 20 microns to 1000 microns. In various embodiments the structure has a thickness in the range of about 20 microns to about 100 microns, or about 100 microns to about 150 microns, or about 150 microns to about 250 microns, or about 250 microns to about 550 microns, or about 550 microns to about 1100 microns. The typical thickness range of the double-sided electrode assembly is about double that of the single-sided assembly structures. In various embodiments the double-sided structure has a thickness in the range of about 40 microns to about 200 microns, or about 200 microns to about 300 microns, or about 300 microns to about 500 microns, or about 500 microns to about 1100 microns, or about 1100 microns to about 2200 microns.

As illustrated in FIGS. 1A-B, electrode assembly structure 100 is monopolar and single-sided (e.g., a single-sided positive electrode assembly), having asymmetric opposing major surfaces with associated surface compositions that are materially different. For instance, first major surface 100-1 may have a homogenous chemical makeup that is wholly defined by inorganic glassy sulfide medium 102 and second major surface 100-2 is not glassy embedded or glassy encapsulated, and in various embodiments (as described herein below) has a chemical makeup that is a heterogenous mix of embedded glassy sulfide electrolyte medium and electroactive material of the network, or homogenous and wholly composed of the electroactive network material. In various embodiments, second major surface 100-2 is defined by current collecting sublayer 115 (e.g., a thin metal layer).

In FIGS. 2A-B glassy embedded electrode assembly 200 is double-sided. In various embodiments, double-sided electrode assembly 200 is monopolar, as both sides of current collecting layer 115 have similar or same porous electroactive networks 110i/110ii (e.g., both having the cathode active material). However, the disclosure is not limited as such, and in other embodiments a double-sided structure of the bipolar type is contemplated, wherein network 110i is composed of cathode active material and network 110ii is composed of anode active material.

The two major material components of the glassy embedded solid-state electrode assembly structure are the electroactive network and the inorganic glassy sulfide electrolyte medium that embeds into the pores of the network and encapsulates it on a major surface. General features and aspects of the two major interpenetrating components are described below and this is followed by a more detailed description of particular/exemplary embodiments with reference to the figures.

Glassy medium 102 is composed in whole, or in part, of inorganic sulfide glass that is highly conductive of Li ions and can have a low softening temperature such that by the application of moderate heat the glass can be caused to wet, flow and/or viscously sinter to itself and wet the electroactive network (e.g., by heating the glass within a temperature range between its glass transition temperature (T_{g}) and its crystallization temperature (T_{c}). The glassy sulfide electrolyte medium is inorganic, highly conductive of Li ions and composed, in whole or in part, of an inorganic sulfide glass having a Li ion conductivity that can be at least 10⁻⁵ S/cm, or at least 10⁻⁴ S/cm. Moreover, the glassy sulfide electrolyte medium 102 is itself highly conductive (e.g., at least 10⁻⁵ S/cm), and can have Li ion conductivity of at least the same order of magnitude as that of the inorganic sulfide glass composition(s) from which it is made (e.g., between 10⁻² S/cm-10⁻⁵ S/cm). In various embodiments, the glassy sulfide electrolyte medium is solely composed of the inorganic sulfide glass, which may be single phase or multi-phase. Glassy sulfide medium 102 is generally composed of one or more glass network formers (e.g., SiS₂, B₂S₃, P₂S₅) and one or more glass network modifiers (e.g., Li₂S, Li₂O) and in some embodiments a dopant may be used for benefit such as to enhance conductivity and/or chemical stability (e.g., LiCl, LiI, Li₃PO₄). Inorganic sulfide glasses suitable for use herein for making glassy sulfide medium 102 are described in U.S. Pat. No. 10,164,289, hereby incorporated by reference for its description relating to structure, composition and fabrication of inorganic sulfide glasses. Glassy medium 102 may be wholly constituted of one or more glass phases, or it may include a dispersion of crystalline phases, including conductive crystalline phases. Such crystalline phases are generally sulfidic Li ion conductors with a composition, size and quantity that may be tailored to tune the coefficient of thermal expansion of the glassy medium and/or elastic modulus and/or mechanical strength. Further details regarding the glassy medium, including its chemical makeup, are provided below, as well as methods of incorporating/embedding the glass into a “preformed” electroactive network, in accordance with manufacturing methods of the present disclosure. As used herein for the sake of readability, the term “Li-sulfide glass” may be used when referring to a Li ion conducting sulfide glass.

As its name suggests, solid electroactive network 110 is composed in whole, or in part, of electroactive material. The type and composition of the electroactive material depends on whether the electrode assembly structure is intended to serve as a positive or negative electrode. When serving as a positive electrode, the electroactive material of the network is composed of cathode active material (CAM), and when serving as a negative electrode it is composed of anode active material (AAM). In other embodiments, a bipolar structure is contemplated with a first electroactive network that is composed of cathode active material on one side of a current collecting layer and a second electroactive network that is composed of anode active material on the other side.

In accordance with embodiments of this disclosure, the electroactive network is a porous solid, and the electroactive material of the network is an inorganic solid. In various embodiments the electroactive network is composed solely of electroactive solid inorganic material, and therefore devoid of organic material components such as organic binders which might otherwise be used to provide cohesion or adhesion to a current collector. For instance, in various embodiments electroactive network is a binder-less solid inorganic layer or sheet of one or more inorganic electroactive material phases.

In various embodiments the overall geometric shape and size of electrode assembly 100/200 is determined by that of its electroactive network 110. In various embodiments the electroactive network is a substantially flat layer having a regular well-defined planar shape and dimension, such as rectangular, oval or circular (e.g., rectangular). A rectangular electroactive network typically has a width of at least 1 cm and length of at least 1 cm. For instance, a width of about 1 cm-5 cm, or about 5 cm-10 cm, or about 10 cm-20 cm and a length to width ratio of about 1 (e.g., a 5 cm by 5 cm square), or about 1.5 (e.g., a 5 cm by 7 cm rectangle), or about 2 (e.g., a 10 cm by 20 cm rectangle), or about 2.5 (e.g., a 10 cm by 25 cm rectangle), or about 3 (e.g., a 10 cm by 30 cm rectangle). In various embodiments, the electroactive network is cut to size from a larger material sheet, which, in certain embodiments may be formed as a continuous or semi-continuous tape or coating. In other embodiments the electroactive network may be formed as a discrete unit that may be shaped and sized by trimming its edges.

In accordance with various embodiments of the present disclosure, electroactive network 110 is a porous preformed solid of electroactive material, and typically has a total pore volume less than 50%, and generally ranges from about 10% to 50%; for instance, from about 10% to 20%, or about 20 to 30% or about 30% to 40%, or about 40% to 50%. Void volumes of about 5 to 10% are also contemplated. Thickness of network 110 generally ranges from about 10 umm to 1000 umm; for instance, between 10 umm to 20 umm, or between 20 um-50 umm, or between 50 um-100 umm, or between 100 umm-200 um or between 200 um-500 umm, or between 500 um-1000 um.

In various embodiments solid electroactive network 110 can be of sufficient strength to be a freestanding layer, and for example readily handleable. In accordance with embodiments, the internal pore microstructure and thickness of the network may be tailored for a particular end use application of the electrode. For instance, in some embodiments the electrode assembly structure is intended for use in a high-power fully solid-state electrode capable of supporting a battery electrical current that corresponds to high area current densities (i.e., current per unit area of the electrode structure) in the range of about 5 to 10 mA/cm², or greater. In other embodiments the electrode assembly structure has a thickness and pore structure that is tailored for use in a high-energy fully solid-state electrode assembly that enables a battery cell of high energy density (e.g., greater than or about 500 Wh/l, or greater than or about 750 Wh/l or greater than or about 1000 Wh/l) and/or high specific energy (e.g., greater than or about 200 Wh/kg or greater than or about 300 Wh/kg or greater than or about 400 Wh/kg).

In various embodiments, glassy embedded electrode assembly 100/200 is a positive electrode assembly that serves as a positive electrode in a battery cell, and in such embodiments electroactive network 110 is composed of one or more cathode active materials.

In various embodiments, the cathode electroactive material is a compound of at least one metal and one or more of oxygen and sulfur and phosphorous (e.g., transition metal oxides, transition metal sulfides, and transition metal phosphates). In embodiments, the metal oxide or metal sulfide or metal phosphate active material is a Li ion intercalation material, as is understood in the battery art. In various embodiments, Li ion intercalation compounds (e.g., lithium metal oxides) are particularly well suited as the active material herein because they substantially retain their atomic structure after repeated charging and discharging cycles. Without limitation, particularly suitable transition metals for the metal oxide or metal sulfide or metal phosphate intercalation compounds are Co, Fc, Ni, Mn, Ti, Mo, V, and W. Particular examples include lithium nickel oxide (LNO), lithium nickel cobalt aluminum oxide (NCA), lithium cobalt oxide (LCO) lithium nickel cobalt manganese oxide (NCM), nickel cobalt aluminum manganese oxide (NCAM) and lithium iron phosphate (LFP). When making an electroactive network, the cathode active intercalation materials include those which may be fully or partially lithiated as well as those which are un-lithiated in their as-prepared state. In various embodiments the cathode active material may be of single compositional phase, or a preformed electroactive network may be fabricated from a plurality (two or more) of phases (e.g., a combination of metal oxide and metal sulfide or metal phosphate intercalation materials or two or more different metal oxide intercalation materials or two or more metal sulfide intercalation materials, or two or more transition metal phosphate intercalation materials, and combinations thereof). In various embodiments, electroactive network 110 is composed of a particular type (or phase) of cathode active material. In other embodiments, glassy embedded electrode assembly structure 100/200 may be used in a negative electrode assembly that serves as a negative electrode in a battery cell, and electroactive network 110 is composed of one or more anode electroactive materials. Without limitation, the following materials are suitable for use herein as anode electroactive materials including lithium intercalating and alloying materials such as carbons (e.g., graphite and synthetic carbon), silicon and lithium titanates and combinations thereof.

In various embodiments the electroactive material of the network and the Li-sulfide glass of the glassy medium is selected for their chemical and electrochemical compatibility with each other. In such instances, the glassy medium may be embedded into the network in direct touching contact with electroactive material. In various embodiments a protective thin layer covers the electroactive material to minimize or eliminate direct contact. For instance, prior to glassy embedding, the protective layer is applied to a surface of the electroactive material or over the electroactive network as a whole (including the internal pore surfaces). The protective thin layer enhances interfacial properties within the body of the structure without imparting an unduc resistance to Li ion migration, and is typically of nanometer thickness (i.e., a nanofilm). For example, the nanofilm thickness may range from about 200 nm to 2 nm (e.g., about 100 nm, or about 50 nm or about 20 nm or about 10 nm or about 5 nm). In various embodiments the protective nanofilm enables the use of electroactive materials (e.g., high voltage CAMs) that are otherwise chemically incompatible in direct contact with the glassy medium. As described in more detail below, the protective nanofilm may be applied onto a preformed porous electroactive network in a manner that coats exterior and interior surfaces of the porous network. Details regarding the chemical makeup and methods for applying the nanofilm onto the surface of the electroactive material or preformed electroactive network are also described below.

A glassy embedded electrode assembly of the present disclosure is generally a composite material assembly of first and second interpenetrating component structures having different material makeups and functionality: a first structure that is a porous solid electroactive network (generally identified in the figures by numeral X10, where X is the Figure number) and a second structure that is a continuous Li ion conductive inorganic glassy sulfide medium (generally identified in the figures by numeral X02), which encapsulates the electroactive network on a first major surface and extends into its depth to form a three-dimensional solid-state interface between itself (the glassy medium) and the electroactive network. In various embodiments the glassy embedded electrode assemblies of the present disclosure may be differentiated by the material makeup and structure of the electroactive network.

Porous solid electroactive network 110 may take several forms. In various embodiments solid electroactive network 110 is a porous body that is preformed prior to it being glassy embedded (i.e., a preformed network). When preformed, the solid electroactive network is generally formed in the absence of glassy sulfide medium, and thus, in various embodiments, the preformed network is devoid of sulfide glass and more generally devoid of any sulfidic Li ion conductor, glassy, crystalline, or otherwise. In other embodiments the solid-state electrode assembly structure is an in-situ formed composite construct, and the solid electroactive network is not a preformed body. In-situ formed composites are generally fabricated by combining electroactive material particles and glassy sulfide media particles to effectuate an in-situ formed interpenetrating system of a solid electroactive network embedded by a glassy sulfide medium. The term in-situ is used herein as it indicates that the solid electroactive network (and the glassy medium) is formed as a result of the assembly fabrication.

In various embodiments the electroactive network is preformed prior to fabrication of the electrode assembly, and, in particular embodiments, preformed in the absence of organic material or glassy sulfide media, and generally binder-free. For instance, in various embodiments the preformed solid electroactive network is a porous monolith composed of electroactive material in the form of a continuous and coherent porous electroactive body. For example, in accordance with the present disclosure a preformed electroactive network is fabricated (e.g., as a monolith) prior to impregnating it with glassy sulfide media. Generally, the porous electroactive monolith is devoid, in its preformed state, of solid inorganic glassy sulfide electrolyte medium. For instance, a porous electroactive monolith may be fabricated by one or more of the following techniques, including partial sintering of one or more electroactive materials to form a porous electroactive monolithic sheet or layer or membrane, or by sintering electroactive material to full or partial densification followed by engineering anisotropic pores (e.g., substantially vertical) into the monolith to form the desired electroactive network structure, or reactively sintering electroactive precursor materials into a porous electroactive monolith (e.g., a porous sheet or porous membrane). By partial sintering it is meant sintering until incomplete densification (e.g., at a low or insufficient sintering temperatures).

In other embodiments the preformed solid electroactive network is not monolithic but rather a composite composed of a contiguous arrangement of discrete electroactive material particles conjoined together generally by means of a binder material (e.g., an organic binder). For example, the preformed electroactive network may be slurry coated/cast onto a current collecting substrate or extruded as a freestanding composite sheet of electroactive material particles and a binder or as a continuous self-supporting dry coated film.

In yet other embodiments solid electroactive network is not preformed prior to glassy embedding but rather materializes as an in-situ formed network when processing the assembly in combination with forming a glassy sulfide medium. For example, by hot isostatically pressing and heating a mixture of electroactive material particles and Li ion conductive glassy sulfide media in a manner to effectuate an interpenetrating composite.

Features, properties and methods for making the glassy embedded electrode assemblies of the present disclosure are highly dependent on the type of solid electroactive network (i.e., a preformed porous monolith, a preformed contiguous structure, or an in-situ composite formed by hot isostatically pressed, for example). Each of these embodiments are now described in more detail herein below.

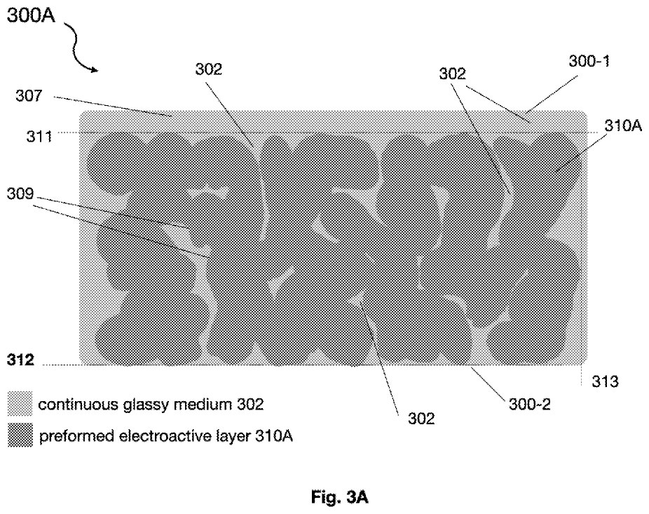

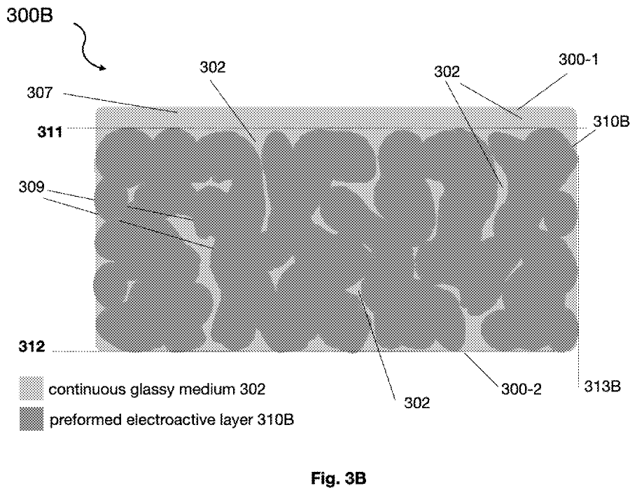

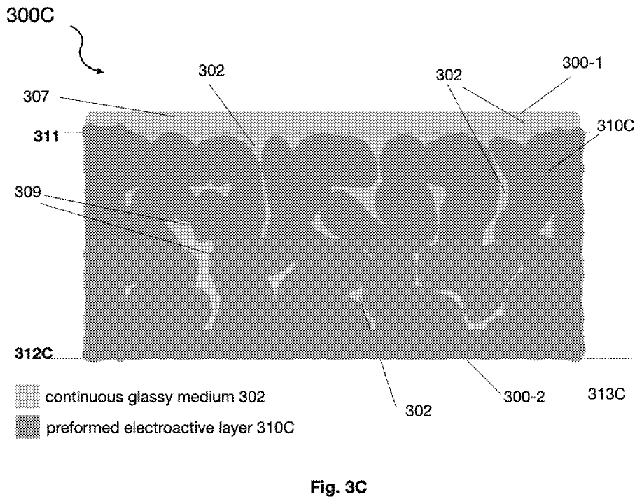

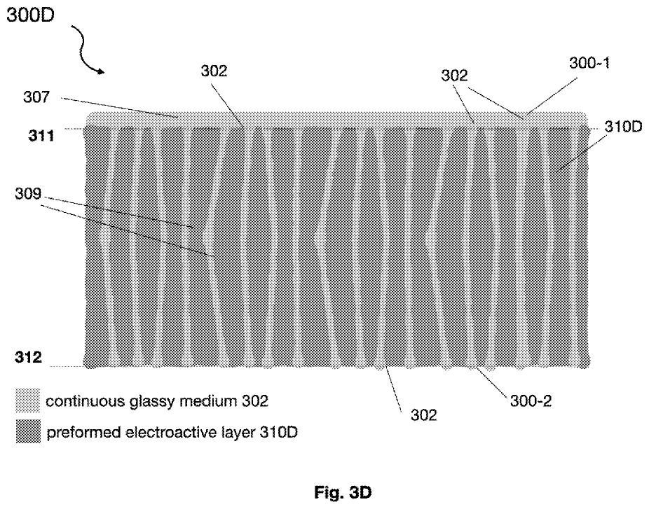

With reference to FIGS. 3A-D there are illustrated in cross sectional depiction single-sided asymmetric glassy embedded solid-state electrode assembly structures 300A-D in accordance with various embodiments of the present disclosure. Assembly structures 300A-D are interpenetrating composite materials composed of first and second interpenetrating material components. First interpenetrating material component 310A-D is a solid electroactive network in the form of a porous preformed monolith of electroactive material having first and second opposing surfaces 311/312. Second interpenetrating material component 302 is a continuous inorganic glassy sulfide electrolyte medium, which, highly conductive of Li ions, embeds interior pore regions and encapsulates monolith first surface 311 to effectuate glassy cover region 307. When incorporated in a battery cell, glassy cover region 307 provides a material layer of positive separation between monolith 310A-D and an opposing electrode in the cell (not shown).

In various embodiments preformed monolith 310A-D is a freestanding or freestandable construct in the absence of a substrate (i.e., substrateless). In various embodiments the preformed monolith is a porous sintered sheet or membrane of electroactive material; for instance, a partially sintered sheet or membrane (e.g., monoliths 310A-C) or a fully or partially sintered construct with directional porosity that is engineered into the monolith post sintering (i.e., after the sintering step); for example, by using laser etching (e.g., see monolith 310D).

In various embodiments internal surfaces 309 and network major surface 311 are coated with a protective nanofilm (not shown) that is transparent to Li ions and provides an improved interface between the monolith and the embedded glassy sulfide medium. The nanofilm, as described in more detail herein below, is not electroactive (i.e., it does not undergo electrochemical reduction or oxidation during cell discharge/charge) or it is generally not considered an electroactive material for the reason that it is either not electroactive or, if it is fully or partially electroactive, it is not reversible or the mass of the nanofilm is such that it provides negligible or immeasurable reversible ampere-hour capacity, or no ampere-hour capacity.

Structures 300A-D are considered single-sided and asymmetric because their first and second major opposing surfaces 300-1/300-2 have different chemical makeups. Surface 300-1 is wholly defined by continuous glassy sulfide medium 302 and second major surface 300-2 is defined, at least in part, by a surface that includes electroactive material.

Thickness of the electrode assembly depends, in part, on the combined thickness of monolith 310A-D (which is measured between major surfaces 311/312) and glassy cover region 307 (which is measured from electrode assembly surface 300-1 to monolith surface 311). Thickness generally ranges from about 10 um-1000 um for electroactive monolith 310 and from about 1 um to 50 mm for glassy region 307. A glassy cover region less than 1 um is also contemplated (e.g., 0.1 to 1 um). Glassy embedded electrode assembly structures incorporating a thin monolith (e.g., less than 100 um or less than 50 um) generally have a thin glassy cover region, and thicker monoliths may have a thicker glassy cover region. Non-limiting examples include a monolith having thickness in the range of 10-20 um and a glassy cover region thickness in the range of 1 to 5 um, or a monolith having thickness in the range of 20 to 50 um and a glassy cover region thickness in the range of 5 to 10 um, or a monolith having thickness in the range of 50 to 200 um and a glassy cover region thickness in the range of 10 to 20 um, or a monolith having thickness in the range of 200 to 500 um and a glassy cover region thickness in the range of 10 to 30 um, or a monolith having thickness in the range of 500 to 1000 um and a glassy cover region thickness in the range of 10 to 50 um.

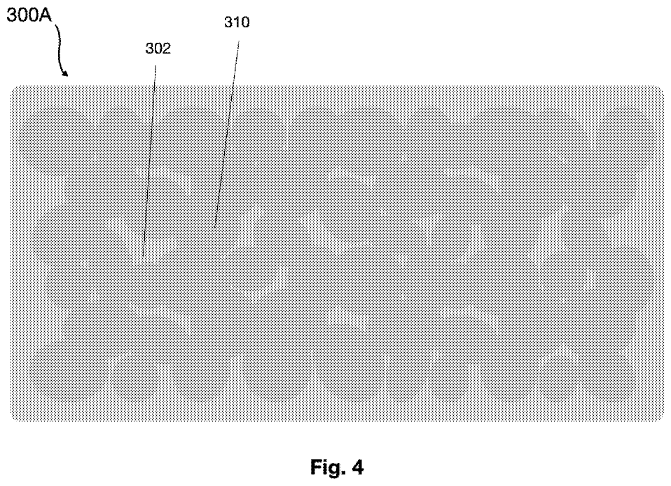

In accordance with various embodiments, glassy medium 302 may be moderately or substantially transparent to visible and/or infrared light. In FIG. 4 glassy embedded electrode assembly 300A is shown in top view from the perspective of looking directly at major surface 300-1 and peering through glassy cover region 307, revealing the boundary with electroactive network 310. Transparency of glassy medium 302 allows for visual inspection of the interior portions of glassy cover region 307 and in some embodiments the interior three-dimensional interface between the monolith pore surfaces and the glassy medium may be inspected in a similar manner. By peering through surface 300-1 embedded features may be observed/detected such as by the human eye (e.g., when glassy medium 302 is visibly transparent) or via optical detection techniques (e.g., IR or visible microscopy), and thus employed for inspection and defect detection in accordance with quality control manufacturing aspects of the present disclosure.

With specific reference to glassy embedded electrode assembly 300A shown in FIG. 3A, continuous glassy medium 302, in addition to providing glassy cover region 307, also blankets/encapsulates at least a portion of the edges about the periphery of the electroactive monolith; for instance, glassy medium 302 fully encapsulating peripheral edges 313.

With specific reference to FIG. 3B electroactive material of monolith 310B is exposed at peripheral edge 313B, and so not edge encapsulated. Or, with reference to FIG. 3C, monolith 310C is fabricated to effectuate a substantially dense peripheral edge region 313C and a substantially dense backplane region 312C that defines surface 312. In other embodiments electrode assemblies are contemplated having a monolith with one or the other of a substantially dense backplane region or substantially dense peripheral edge region.

With specific reference to FIG. 3D, in various embodiments glassy embedded electrode assembly 300D has an electroactive network 310D that is a monolith with an engineered pore structure that is made by fabricating a monolithic body (e.g., by sintering partially or substantially to full density) and then engineering directional highly anisotropic pores using lithographic techniques and other processes such as laser structuring as described in more detail herein below.

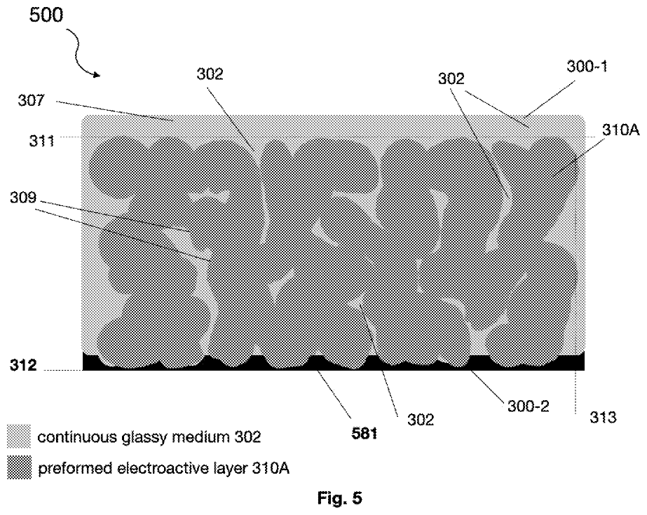

Glassy embedded electrode assemblies of the present disclosure generally include a current collecting layer that may be placed or deposited onto the surface of electroactive network surface 312 (not shown in FIGS. 3A-D). By way of example, current collecting layer 581 is illustrated in FIG. 5 for a single-sided glassy embedded electrode assembly 500. The composition of the current collecting layer depends in part on its stability against the electroactive material. In various embodiments current collecting layer 581 is metallic. For instance, when glassy embedded electrode assembly 500 is a positive electrode assembly, current collecting layer 581 may be an aluminum layer or another stable metal layer (e.g., titanium) or a combination of metal layers that are suitable for use at the potential of the cathode active material. And likewise, for a negative electrode assembly, current collecting layer 581 may be a copper layer, or other suitable metal layer (e.g., nickel or titanium, or an aluminum layer for an anode active material above about 1.5V vs. Li/Li⁺), or some combination thereof. Thickness of current collecting layer 581 depends, in part, on how it is applied onto or incorporated into the composite assembly structure. Physical vapor deposition techniques known in the art of metallization may be employed, including vacuum metallization (e.g., thermal/vacuum evaporation) and the like. When it is applied by physical vapor deposition techniques, thickness of current collecting layer 581, is generally about 5 um or less (e.g., about 3 um or about 2 um or about 1 um); for instance, between 0.1 to 1 um thick. The deposition of a current collecting layer onto monolith surface 312 is advantageous in that it may more readily form an intimate contact with the electroactive material of the monolith, as opposed to merely placing a current collecting foil onto the surface.

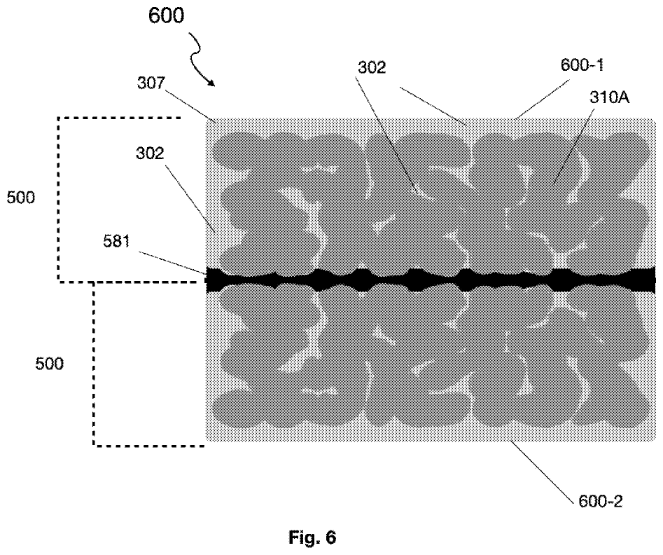

It should be readily apparent to one of skill in the art that the description above for an electrode assembly having a single-sided configuration is equally pertinent for assemblies having double-sided configurations. In various embodiments, a double-sided electrode assembly may be constructed by simply stacking a pair of identical single sided assemblies in a back-to-back fashion. In FIG. 6 double-sided electrode assembly 600 is illustrated in cross-sectional depiction, in accordance with various embodiments of the present disclosure. In various embodiments a simple stacking of first and second identical single-sided electrode assemblies may be employed for making double-sided assembly 600. In various embodiments a tie layer (not shown) may be used between opposing current collecting layers 581 to enhance mechanical or electrical contact, and/or a discrete current collecting layer or foil (e.g., a Cu or Al metal foil) may be disposed therebetween for collecting the current and providing an external connection such as a tab.

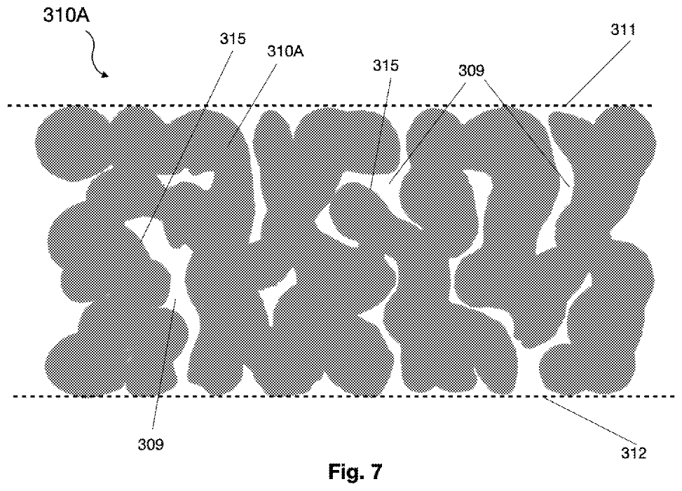

As described above with reference to FIGS. 3A-D, FIG. 5 and FIG. 6, in various embodiments electroactive network 310A-D is a preformed porous monolith of electroactive material that is fabricated as an intermediate component in the making of an electrode assembly, and in the absence of glassy sulfide media. For instance, as illustrated in FIG. 7 porous electroactive monolith 310A (as already described in the context of glassy embedded electrode assembly 300A, in FIG. 3A) is depicted in FIG. 7 as intermediate component in its preformed state prior to being glassy embedded. In particular, preformed monolith 310A is a coherent binder-less network entirely composed of continuous solid inorganic electroactive material with an interior network of pores 309 and pore surfaces 315 engineered to receive glassy sulfide media to form a continuous interpenetrating glassy sulfide medium within the depth of the network pore structure. In various embodiments, monolith 310A is “preformed” by partial sintering cathode active material, as described in more detail below.

In various embodiments the preformed monolith is a substantially flat membrane or sheet having regular planar dimensions (e.g., rectangularly shaped) and devoid of glassy sulfide media. Typically, the monolith has width of at least 1 cm and length of at least 1 cm. In embodiments a preformed monolith is formed as a continuous sheet that is cut to size; for instance, formed as a continuous sheet having a certain first dimension (i.e., width) and cut to its desired second dimension (i.e., length). In other embodiments the monolith is formed as a discrete unit having a discrete geometric shape and size (e.g., rectangular sheet of a certain width and length dimension). In embodiments, monolith 310A-D has width of about 1 to 5 cm or about 5-10 cm, or about 10-20 cm and a length to width ratio of about 1 (e.g., 5 by 5 cm), or about 1.5 (e.g., 5 by 7 cm), or about 2 (e.g., 10 by 20 cm), or about 2.5 (e.g., 10 by 15 cm).

The electroactive monolith is that component of the electrode assembly that provides ampere-hour capacity when incorporated in a battery cell. The areal capacity (mAh/cm²) of the electrode assembly depends on the gravimetric capacity (mAh/g) of the electroactive material from which the monolith is composed and the mass of electroactive material per unit area, which, in turn, depends on thickness and pore volume of the monolith. Pore volume is typically less than 50%, and generally ranges from about 10% to 50%; for instance, from about 10% to 20%, or about 20 to 30% or about 30% to 40%, or about 40% to 50%. Pore volumes from about 5 to 10% are also contemplated. Monolith thickness generally ranges from about 10 mm to 1000 mm; for instance, between 10 mm to 20 mm, or between 20 mm-50 μm, or between 50 um-100 mm, or between 100 mm-200 mm or between 200 mm-500 mm, or between 500 mm-1000 mm.

In various embodiments the preformed porous monolith is a based on a sintered body (e.g., a sheet or membrane formed by sintering a green body composed of the electroactive material and a binder) that is composed solely of solid inorganic material, and therefore devoid of organic material components such as organic binders which might otherwise be used to provide cohesion to a composite layer coating or otherwise an un-sintered product. For instance, the porous monolith may be a binder-less solid inorganic layer of one or more electroactive material phases.

In various embodiments, the preformed monolith is fabricated by sintering a green body of electroactive material generally in the form of a green sheet or tape, as is known in the ceramic sintering arts, and firing the green body to fuse the electroactive materials while burning off the binder in the process. Processes for making dense and porous sintered electroactive bodies for positive and negative electrodes for use in lithium-ion batteries are described in International Patent Publication No.: WO 2019/089926 entitled Sintered Electrode Cells for High Energy Density Batteries and Related Methods Thereof. Sintered electrode layers made by slurry casting a green tape layer and sintering the layer are described in U.S. Patent Application NO.: 2016/067455 entitled Slurry Formulation for the Formation of Layers for Solid Batteries. Tape cast and sintered layers are also described in WO 2019/089926, entitled Sintered Electrode Cells for High Energy Density Batteries and Related Methods Thereof.

In various embodiments, the sintering method involves creating a solid form such as a coating on a substrate (e.g., on a setter plate) or forming a green tape of the active material particles, such as by tape casting or slip casting or forming the green coating or green layer by spray drying or pressing or roll compaction or paste coating or casting into a mold, or formed by injection molding, or freeze casting (i.e., ice-templating) and then drying and firing the green construct at temperatures sufficient to induce sintering. In various embodiments, the pore structure and porosity are tailored by controlling the time, temperature and pressure at which the green tape or construct is sintered.

In various embodiments the preformed electroactive network is formed by partially sintering electroactive material particles, including both surface constrained and pressure-less sintering. In various embodiments, reactive sintering may be used to generate the porous construct. Phase segregation or a sacrificial phase may be used to generate pores. For instance, a slip-cast suspension of electroactive particles in a polymeric foam followed by burnout of the organic material and sintering. Or the porosity and pore structure of the electroactive network may be engineered by incorporating fugitive pore formers as is known in the art, of various shapes and sizes, including long rod-shaped fugitive particles that burn off during the sintering stage.

By controlling sintering parameters (e.g., time, temperature, atmosphere), electroactive powder morphologies (e.g., particle size, shape and particle size/shape distribution), green slurry composition including pore formers, the pore structure may be engineered to facilitate infiltration with glassy sulfide media while optimizing electrochemical performance and enhancing mechanical properties. In various embodiments preformed monolith has an expansive porous network with a pore structure that is engineered to minimize or eliminate dead end pores (sometimes called closed pores), which may be closed off to infiltration, while enhancing pores with through passages. For instance, through passageways may exist as straight through pores or pores that extend from the monolith first surface through to a peripheral edge.

In particular embodiments, a sintered monolith is prepared by initially forming a green tape having thickness ranging from about 20 um to 1200 um (e.g., between 20-50 um or between 50-100 um, or between 100-200 um, or between 300-400 um or between 400-500 um or between 500-750 um or between 750-1000 um). For example, active material particles may be dispersed in a slurry that is cast into a green tape using slip casting or casting onto a carrier and spreading the slurry coating to the desired thickness using a doctor blade. Once cast, the green tape is dried of the liquid carrier from the slurry, and then sintered at elevated temperature (e.g., at temperatures of about 600° C. to 1500° C.) using a time and temperature profile sufficient to sinter the construct as a porous electroactive network.

With reference to FIGS. 3A-D, in various embodiments, pore structure of sintered monolith 310A-D includes through pores that extend from first surface 311 to second surface 312. For instance, monolith 310A-D having a combination of through pores and open pores. In various embodiments, the porous preformed monolith does not have through pores; for instance, a majority of the pore volume (e.g., at least 90%) is composed of open pores that do not extend through. In various embodiments, the sintered electrode has a thickness from about 10 microns to 1000 microns; for example, from 20 to 100 um, from 100-200 um, from 200-300 um, from 300-500 um, from 500-750 um, from 750-1000 um. The porosity of the preformed network is generally less than 50%, and typically between 5-10%, or between 10-20%, or between 20-30%, or between 30-40%, or between 40-50%. In various embodiments, first surface 111 and second surface 112 are substantially parallel and flat. The area capacity of the electroactive network typically ranges from 0.5 mAh/cm² to 10 mAh/cm², for example between 0.5-1 mAh/cm², between 1 to 2 mAh/cm², between 2 to 3 mAh/cm². The electroactive network may be formed as a porous construct by partial sintering of electroactive material and/or by sintering active materials in the presence of a pore former. The partially sintered electroactive network can be sufficiently formed to effectuate a fully connected porous network that is of sufficient strength to withstand further processing such as glassy embedding when forming the electrode assembly structure, as described in more detail below.

In various embodiments, the desired pore structure of may be achieved by partial sintering and controlling the particle size and particle size distribution of the active material particles used for making the green construct or tape (i.e., a pre-sintered layer). The porosity of the layer may be varied along the depth of the electroactive layer by applying multiple coatings when making the green tape (i.e., using multilayer tape casting). For example, each layer of the multilayer tape may be coated using a slurry having active material particles of different size and dimension. For instance, the first layer may be coated from a large particle size slurry to effect large pores and yield more void volume near the backplane of the electrode structure and the final layer, near the first surface, coated with a smaller particle size slurry, leading to higher fraction of electroactive material nearby the first surface. In other embodiments, sintered preformed electroactive network may be sintered to achieve a first pore structure and first surface microstructure and the sintering operation followed by an engineering operation for creating additional pore features into the network and an engineered microstructure on its first surface, such as by laser structuring, including programmable laser structuring and laser ablation. The engineered microstructures serve to enhance material interlocking at the solid-state interface between the electroactive network and the glassy medium. In various embodiments, tunable sized pores (e.g., vertical pores) are created that extend from the first monolith surface to the second surface. Freeze casting the green construct, is a particularly suitable method for forming one dimensional anisotropic straight through pores. Various lasers may be used to effectuate the desired pore structure, including excimer lasers, ns fiber lasers, and fs-lasers). Using these techniques, the pore structure of the electroactive network and its first surface microstructure can be engineered to improve charging and discharging rates of the electrode, for example by incorporating primary and secondary pore structures within the depth of the electroactive network.

After making a preformed porous electroactive monolith, the next major step for processing the electrode assembly is to infiltrate the pores with glassy sulfide media in a manner that effectuates a continuous glassy medium or can be further processed to the same effect. The structure provides electrokinetic benefit as it effectively increases the active surface area for Li ion transport relative to the planar dimensional area of the monolith. These advantages lead to enhanced power output, reduced charging time and/or improved cycle life. A robust embedded interface with enhanced stability and greater internal pore surface coverage is highly desirable. In accordance with the present disclosure, the properties of the embedded interface may be improved by modifying the chemical makeup of the internal pore surfaces, and, in particular, this may be achieved by providing a protective layer that encapsulates the surfaces with a conformal protective thin film that is Li ion transparent. In various embodiments the protective film stabilizes the interface by acting as a barrier layer between the glassy sulfide media and electroactive material of the network, eliminating oxidation of sulfide to SO₂ or sulfidation of the electroactive material, or other mechanisms of interface degradation.

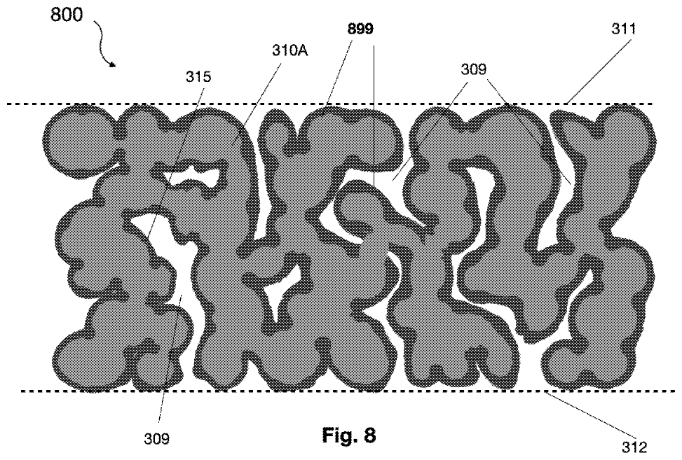

In FIG. 8 nanofilm protected porous electroactive network 800 is illustrated. Network 800 may be a partially sintered monolith of cathode active material that is protected by nanofilm 899, covering, in direct contact, network internal and external surfaces 315/311, in accordance with various embodiments of the present disclosure. Protective nanofilm 899 is useful for mitigating or eliminating adverse reaction between the electroactive material and the glassy sulfide medium when in direct contact. It may also provide additional benefit in terms of wettability with the sulfide glass during the embedding process. It should be apparent that a protective nanofilm may be incorporated into the various electroactive monolith embodiments that have thus far been depicted throughout the specification. For instance, a protective nanofilm on the surfaces of electroactive network 310A-D shown in FIGS. 3A-D, is generally employed.

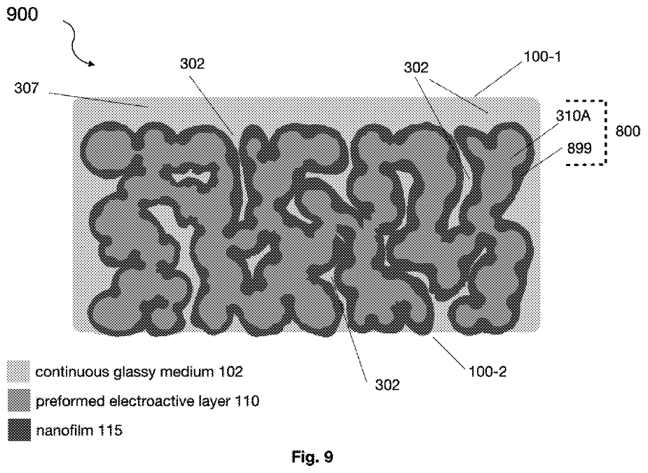

In FIG. 7 monolith 310A is shown in its preformed state; in FIG. 8 monolith 310A is shown having conformal protective nanofilm 899 covering internal pore surfaces 315 and major surface 311; and in FIG. 9 glassy embedded electrode assembly 900 is shown, including glassy continuous sulfide medium 302 embedded into the depth of the nanofilm protected monolith 800.

Protective nanofilm 899 is typically of thickness in the range of 1 to 500 nm (e.g., about 1 nm, or about 5 nm, or about 10 nm or about 20 nm or about 50 nm or about 100 nm or about 200 nm or about 300 nm or about 400 nm or about 500 nm). Without limitation, suitable compositions for the nanofilm include lithium metal oxides Li₂SiO₃, Li₄Ti₅O₁₂, LiTaO₃, LiAlO₂, Li₂O—ZrO₂, Li₂ZrO₃, Li₂TiO₃, LiNbO₃, and metal oxides, such as Al₂O₃, TiO₂, ZrO₂, V₂O₅, and also contemplated are metal phosphates (e.g., manganese phosphate, cobalt phosphate, iron phosphate, and titanium phosphate, metal fluorides (e.g., aluminum fluoride, lithium aluminum fluoride, iron fluoride, and the like), metal oxyfluorides, and metal hydroxides. The nanofilm may be formed by chemical vapor deposition, including atomic layer deposition (ALD), as well as other wet chemical methods, including sol gel coating of a nanofilm layer. (e.g., a nanofilm composed of aluminum or niobium and oxygen) using a chemical vapor deposition technique such as atomic layer deposition (ALD) or a wet chemical method for making thin adherent films, such as sol-gel. The nanofilm induces wetting of sulfide glass and its thickness is a tradeoff between providing sufficient surface coverage to protect the active material from adverse sulfidation and maintaining an ion transfer interface across the nanofilm. ALD is particularly applicable as it is a gas phase technique that produces uniform, conformal films from gaseous reactants that enter the passageways and channels of the porous network and the reaction in a self-limiting manner, so it coats the surface with exceptionally thin layer that does not bring about pore blockage. Accordingly, the ALD coated monoliths of the present disclosure, because of both the conformal nature and ability to coat internal pores without clogging, allows for subsequent thorough infiltration of the glassy sulfide media. Accordingly, in various embodiments the nanofilm is coated directly onto the preformed monolith (e.g., by ALD). It is contemplated that the porous electroactive monolith may be processed by sintering an electroactive green body composed of discrete electroactive material particles that are precoated with a protective nanofilm and thus the protective nanolayer is effectuated in-situ with sintering the monolith. In various embodiments both techniques may be employed. The electroactive material particles, prior to sintering, are coated with the protective nanofilm (e.g., by ALD or a wet synthesis approach) and the sintered monolith (with its pore structured already formed) is further processed by ALD to provide additional coverage over surfaces that may have become exposed during sintering or more generally to enhance full coverage, as needed.

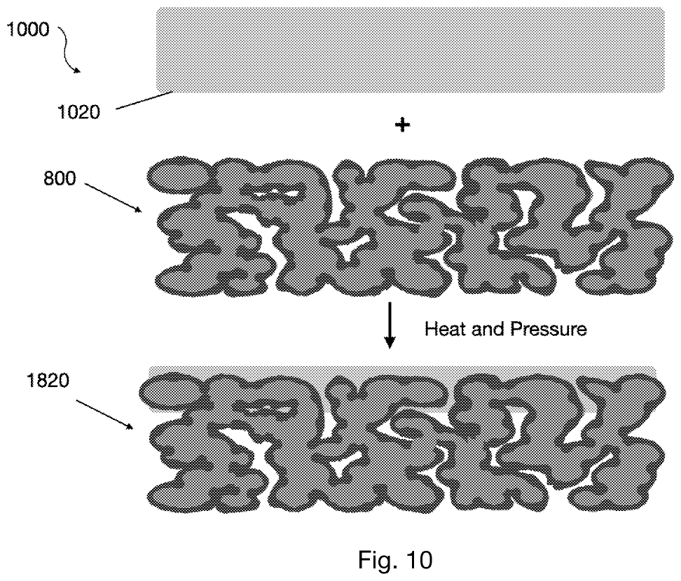

FIGS. 10-12 illustrate methods for making a glassy embedded electrode assembly that includes glassy embedding a preformed electroactive network, including high and low temperature approaches and processes for infiltrating the glass into the pores of the network. Method 1000 involves heating Li-sulfide glass sheet 1020 and pressing it against monolith 800; method 1100 is a high temperature approach that involves melt casting Li-sulfide glass into the pore structure of the monolith; and method 1200 is a low temperature approach that involves making a “glassy electroactive prepreg” as an intermediate component and heating the prepreg to a temperature that induces viscous sintering (of the glass).

Each method involves initial operation 1001 that includes providing or making a preformed porous electroactive network; for example, a partially sintered monolith of cathode active material. In particular embodiments, the cathode active monolith is nanofilm protected, as illustrated in FIG. 8 (i.e., monolith 800). By incorporating a conformal nanofilm the choice of suitable cathode active materials is expanded to include those that are otherwise incompatible in direct contact with Li-sulfide glasses, and in particular higher voltage cathodes. The nanofilm also provides significant processing advantages against sulfidation of cathode active material in direct contact with hot glass (e.g., above 500 C), and is generally beneficial as a protective layer for lower temperatures processes that involve heating the Li-sulfide glass to temperatures between T_{g} and T_{c}.

With specific reference to FIG. 10, method 1000 involves heating Li-sulfide glass sheet 1020 above T_{g} and pressing it against electroactive monolith 800 with a pressure sufficient to extrude glass into the pores of the monolith. Li ion conducting vitreous sulfide glass sheets described in U.S. Pat. No. 10,164,289 are particular suitable herein as sheet 1020. For deep embedding, whereby the glassy medium extends into and throughout the entirety of the monolith pore structure, the glass should have a sufficiently low viscosity to achieve complete extrusion and this step may require elevated temperatures approaching or exceeding the liquidus temperature of the glass, although lower temperatures (between T_{g} and T_{c}) are also contemplated depending on the glass compositions. In various embodiments, temperatures between T_{g} and T_{c} are sufficient for at least a shallow embedding (e.g., the glassy medium extending into the monolith to a depth that is less than 50% of the monolith thickness). The embedding depth or extent can be increased, or the rate of embedding enhanced, by pressure assisting the capillary flow. An electrode assembly with a shallow embedding is particularly suitable for use in a battery cell having a hybrid construction wherein a liquid or gel electrolyte fills the remaining non-embedded pores.

In some embodiments during the impregnation step (or as a separate step) glassy sulfide media particles may be applied as a thin layer onto the monolith major surface (e.g., by spraying a glass particle slurry) followed by viscous sintering of the sprayed glass particle layer, thus forming the encapsulating glassy cover region.

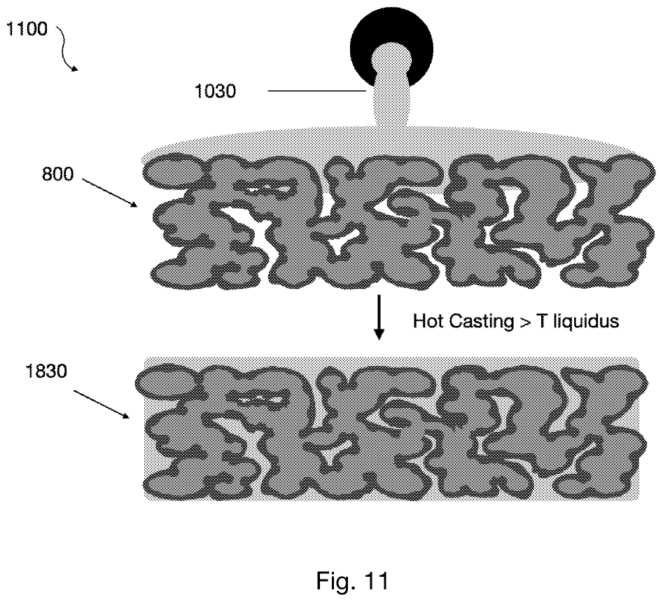

With reference to FIG. 11, casting method 1100 involves heating the glass in a crucible to a high temperature sufficient to reduce the glass viscosity to a level for which it will readily flow and infuse into the monolith pores. Method 1100 is a high temperature approach that involves infiltrating the monolith with molten sulfide glass at or above the liquidus/melt temperature (e.g., above 700° C.). Because it involves hot glass (e.g., above 500° C.), the approach presents several material challenges and therefore generally requires a protective nanofilm that is sufficiently robust to inhibit sulfidation of the electroactive material and oxidation of the glass. Moreover, melt casting requires careful cooling controls to avoid mechanical failure such as cracking the monolith (if cooled too quickly) and undue crystallization of the glass (if cooled too slowly).

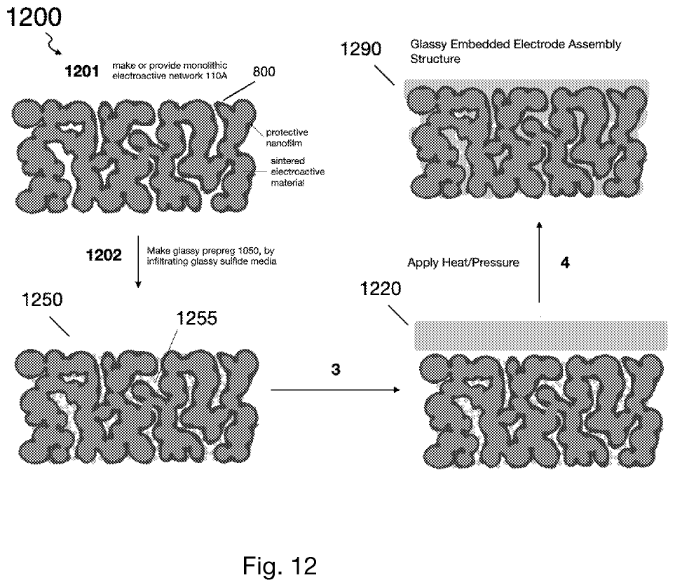

In contrast with the complexities of a high temperature approach, in FIG. 12 method 1200 involves a low temperature approach for making glassy electroactive prepreg 1250 at temperatures typically below 100° C., and more typically below 60° C., and in some embodiments below 40° C., or slightly above 20° C. or at about 20° C. The method for making the prepreg involves vacuum impregnation (i.e., infiltration) of a liquid phase dispersion of Li-sulfide glass particles 1255 in a volatile carrier solvent and evaporating the carrier solvent with low to moderate heat (e.g., 40° C.-60° C.). Once formed, prepreg 1250 is heated to a temperature sufficient to viscously sinter the glass particles to each other, and thus form glassy medium 302. For creating encapsulating glassy cover region 307, Li-sulfide glass sheet 1220 may be pressed with heat onto the monolith surface where it (sheet 1220) viscously sinters to the impregnated glass particles nearby the monolith surface, whereby the glassy embedded electrode assembly 1290 is formed. Viscous sintering involves heating the prepreg above the glass transition temperature T_{g} of the impregnated glassy sulfide media particles and possibly below their crystallization temperature T_{c}. For instance, heating prepreg 1250 to viscous sintering temperatures between T_{g} and T_{c}. In various embodiments the viscous sintering temperature is less than Tc and no more than about 40° C. greater than T_{g}, or no more than about 60° C. greater than T_{g}, or no more than about 80° C. greater than T_{g}, or no more than about 100° C. greater than T_{g}. For example, the viscous sintering operation can take place at a temperature that is above T_{g}, and below T_{c} by at least 20° C., or by at least 30° C. or by at least 40° C. or by at least 50° C. In various embodiments the viscous sintering step may be pressure assisted by applying an inert gaseous pressure about the prepreg during sintering to enhance flow and wetting and/or otherwise enhance densification of the glassy media. In various embodiments, the glassy prepreg may be viscously sintered using hot isostatic pressing (HIP).

Further in accordance with method 1200, glass impregnation is achieved at low temperature (e.g., room temperature) as opposed to melt infiltration or melt casting which requires heating the glass to a hot molten state at high temperatures above the liquidus or melt temperatures.

When making prepreg 1250, impregnation of Li-sulfide glass particles 1255 may be achieved by vacuum infiltration using a liquid phase dispersion of the glass particles in a volatile carrier solvent and/or evaporating the carrier solvent with low to moderate heat (e.g., 40° C.-60° C.). The glass media loading level is controlled by the impregnation process. In embodiments, to effectively impregnate/infiltrate high conductivity sulfide glass into porous cathode structures, it is desirable to produce fine particles, for example below 1 μm in diameter (i.e., submicron). Conductive sulfide glasses (e.g., network formers including P₂S₅, B₂S₃, SiS₂, etc. and network modifier including Li₂S) exhibit plastic deformation which can make them difficult to grind into fine powders. Accordingly, in various embodiments milled sulfide glass powders are ground at subzero temperatures, such ascryogenic temperatures (e.g., by cryo-grinding or cryo-milling) to prevent plastic deformation during grinding and produce micron and sub-micron powders. By subzero temperature it is meant below 0° C. and down to about −150° C. (i.e., 0° C. to −150° C.), whereas by cryogenic it is meant temperatures below −150° C. These ultrafine (e.g., submicron) powders can then be used to infiltrate the cathode structure, including, for instance, three-dimensional sintered cathodes as described herein.

With reference to FIG. 12A, in various embodiments the pore filling sulfide glass infiltration as described above is performed to cause an over-filling in the sense that the infiltration step leaves behind islands of glass on the surface of the electroactive prepreg, and the surface islands are then consolidated into a thin layer of Li ion conducting sulfide glass by hot pressing or hot rolling (e.g., using a heated roller, or using a rolling step combined with applying heat such as by an infrared lamp or laser as the heat source). Additionally, layers of glassy solid electrolyte (e.g., Li ion conducting sulfide glass) may be sprayed onto the islands or onto the thin layer formed from the islands to form a thicker more robust glassy surface encapsulating layer. It is also contemplated that polycrystalline solid electrolyte particles may be infiltrated into the pores of the electroactive layer, and this followed by spraying glassy media on top to form the encapsulating glassy film, as described herein above and below.

In some embodiments, multiple infiltration operations are contemplated. For instance, a first infiltration may be performed using small sulfide glass particles (e.g., <1 um particle diameter) followed by infiltration using larger sized particles (e.g., >1 um particle diameter). In various embodiments the aforementioned carrier solvent may be one or more of saturated hydrocarbon, an unsaturated acyclic hydrocarbon, an unsaturated cyclic hydrocarbon, and an organic carbonate.

Particularly suitable saturated hydrocarbons for use as a carrier solvent are straight-chain alkanes C₅-C₁₁ (e.g., n-Pentane C₅H₁₂, n-Hexane C₆H₁₄, n-Heptane C₇H₁₆, n-Octane C₈H₁₈, n-Nonane C₉H₂₀, n-Decane C₁₀H₂₂, n-Undecane C₁₁H₂₄, n-Dodecane C₁₂H₂₆); branched-chain alkanes C₅-C₁₁ (e.g., Isopentane C₅H₁₂, Isohexane C₆H₁₄, Isoheptane C₇H₁₆, Isooctane C₈H₁₈, Tetraethylmethane C₉H₂₀, Isodecane C₁₀H₂₂, 3-Methyldecane C₁₁H₂₄); cycloalkanes C₆-C₈, CₙH₂ₙ (e.g., Cyclohexane C₆H₁₂, Cycloheptane C₇H₁₄, Cyclooctane C₈H₁₆).

Particularly suitable unsaturated acyclic hydrocarbons (CₙH₂₍ₙ₋ₘ₋₁₎) for use as a carrier solvent are those wherein n is the number of carbon atoms and m is the number of double bonds, such as alkenes (C₆-C₁₁, CₙH₂ₙ; stable to alkali metals), including 1-Hexene C₆H₁₂, 1-Heptene C₇H₁₄, 1-Octene C₈H₁₆, 1-Nonene C₉H₁₈, 1-Docene C₁₀H₂₀, 1-Undecene C₁₁H₂₂, and 1-Dodecene C₁₂H₂₄; and alkadienes (C₆-C₁₂, CₙH₂ₙ₋₂), including 1,5-Hexadiene C₆H₁₀, 2,4-Hexadiene C₆H₁₀, 1,6-Heptadiene C₇H₁₂, 1,7-Octadiene C₈H₁₄, 1,8-Nonadiene C₉H₁₆, 1,9-Decadiene C₁₀H₁₈, 1,10-Undecadiene C₁₁H₂₀, and 1,11-Dodecadiene C₁₂H₂₂.

Particularly suitable unsaturated cyclic hydrocarbons (CₙH₂₍ₙ₋ₘ₎) for use as a carrier solvent are those wherein n is the number of carbon atoms and m is the number of double bonds such as Cycloalkenes C₆-C₈, CₙH₂ₙ₋₂ (e.g., Cyclohexene C₆H₁₀, Cycloheptene C₇H₁₂, Cyclooctene C₈H₁₄; and Cycloalkadienes C₆-C₈, CₙH₂ₙ₋₄ (e.g., 1,3-Cyclohexadiene C₆H₈, 1,4-Cyclohexadiene C₆H₈, 1,3-Cycloheptadiene C₇H₁₂, 1,3-Cyclooctadiene C₈H₁₄).

Particularly suitable organic carbonates for use as a carrier solvent are propylene carbonate (PC) C₄H₆O₃, dimethyl carbonate (DMC) C₃H₆O₃, ethyl methyl carbonate (EMC) C₄H₈O₃, diethyl carbonate (DEC) C₅H₁₀O₃.

In alternative embodiments crystalline Li ion conducting media may be infiltrated into the monolith to form a prepreg and in embodiments, a combination of both crystalline and glass sulfide media may be used.

In another embodiment interior pores and surfaces of the electroactive network may be impregnated and coated using a solution coating method that involves impregnating the porous network with a solution of lithium ion conducting sulfide material dissolved in dissolving solvent (e.g., NMF), and then evaporating the solvent (e.g., with an applied amount of low heat). For instance, a solution of a lithium phosphorus sulfide powder (e.g., having a mol % of 50Li₂S·50P₂S₅, 70Li₂S·30P₂S₅, or 80Li₂S·20P₂S₅). In various embodiments, once the solvent has evaporated, leaving behind the sulfide material in the pores, the layer may be heat treated to enhance connectivity among the infiltrate and/or to cause them to sinter or coalesce within the pore structure.

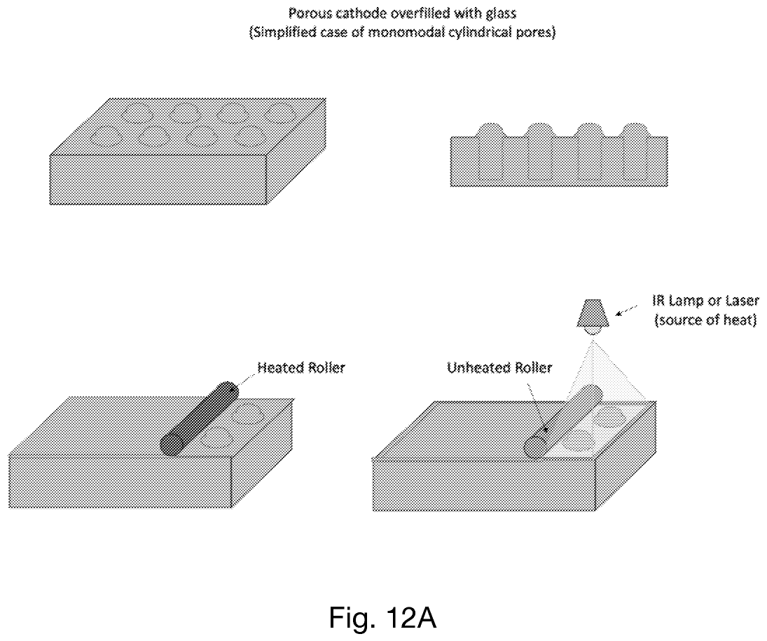

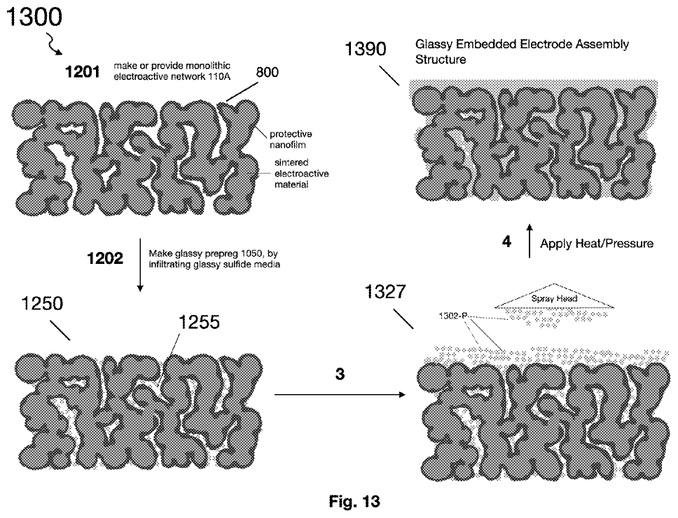

In FIG. 13 is illustrated another method involving a low temperature approach for making glassy electroactive prepreg at low temperature involving applying glassy sulfide media particles as a thin layer onto the monolith major surface (e.g., by spraying a glass particle slurry) at 1327 followed by viscous sintering of the applied (e.g., sprayed) glass particle layer, thus forming an encapsulating glassy cover region 307 of a glassy embedded electrode assembly 1390, in accordance with various embodiments of the present disclosure. In some embodiments, the infiltrated prepreg may be heated to a temperature that viscously sinters the infiltrated sulfide glass particles prior to applying the glassy sulfide media particles as a thin layer onto the surface of the electroactive layer, and this followed by another step of sintering the particles of the sprayed thin layer with heat (e.g., by joule heating or laser heating/polishing to densify the thin layer as encapsulating surface film.

For instance, with reference to FIG. 13A, in embodiments, powders ground at subzero temperatures, or cryogenically ground powders, as described above, are used to produce ultrafine sulfide glass powders (e.g., submicron) that are airbrushed onto a major surface of an infiltrated cathode (i.e., a prepreg), such as a porous sintered monolith or a porous slurry coated electroactive layer. In various embodiments, the prepreg is formed with cryogenically ground sulfide particles. In various embodiments the airbrush process can use a dry inert gas such as dry nitrogen or dry argon to generate a fine mist of sulfide powder in mineral spirits or similar non-reactive carrier fluid. The layer of deposited sulfide powder is then sintered into a continuous glass film, for example in the 1-10 μm thickness range. The sintering step may be done by joule heating or by laser heating and polishing, for example. Advantages of laser heating/polishing are that the infiltrated cathode substrate can be unperturbed by the laser sintering and polishing of the surface. Laser polishing can attain near perfect surfaces with roughness values of Rₘₛ<0.4 nm, which can be helpful for preventing lithium dendrites. For instance, in various embodiments the glassy surface film may be a lithium phosphorous sulfide glass (e.g., an Li₂S—P₂S₅ glass) and lithium metal may be applied directly onto it for battery production. In other embodiments, an interlayer coating or film may be applied onto the thin glassy layer to improve stability in contact with Li metal, such as a silver-carbon composite material layer.

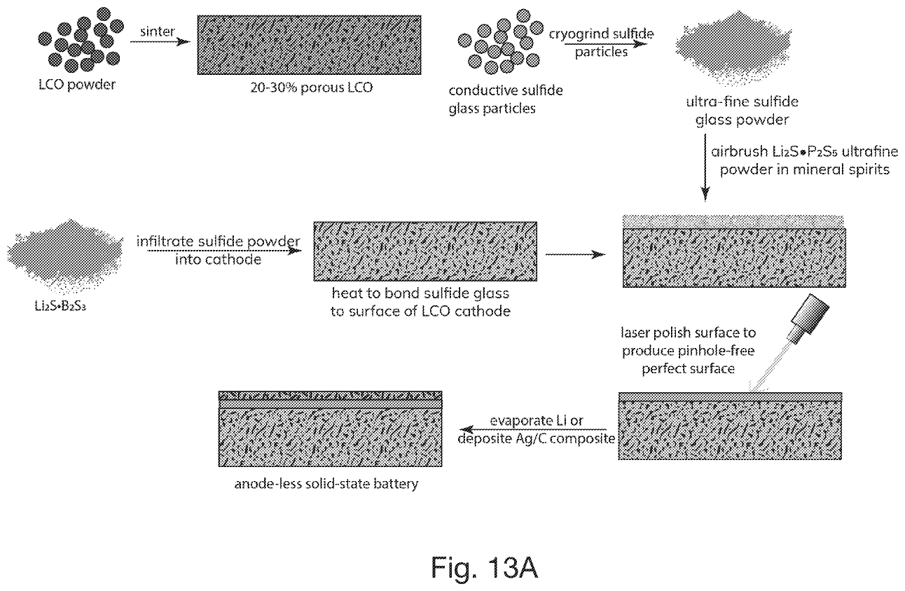

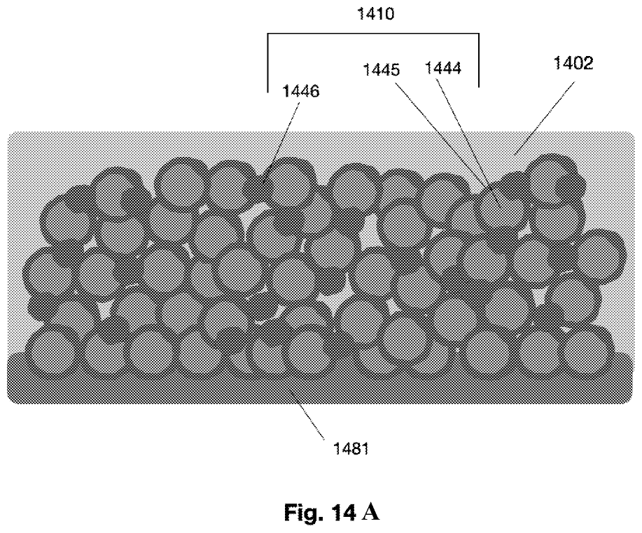

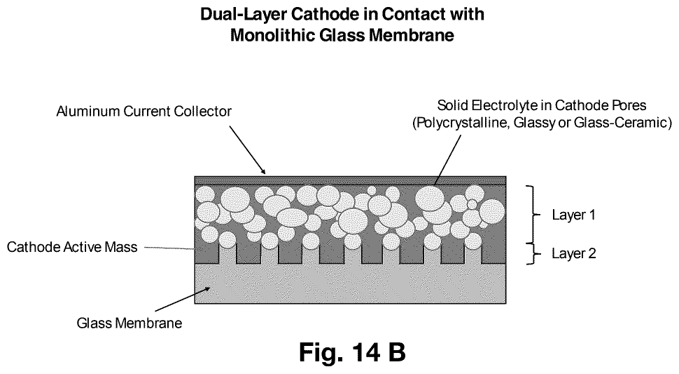

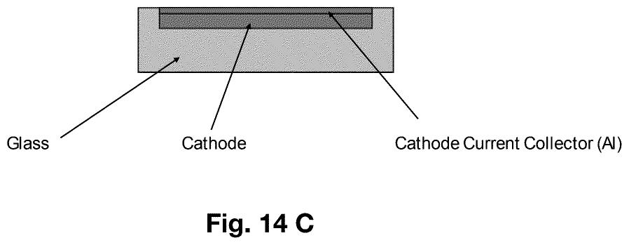

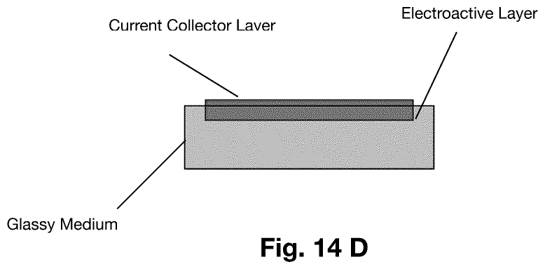

In FIG. 14A alternative glassy embedded electrode assembly 1400 is shown having preformed electroactive network layer 1410 that is not a porous monolith, but a slurry coated layer of discrete electroactive particles 1444 conjoined by binder 1446 and formed on current collector layer 1481. Network 1410 is embedded by glassy medium 1402, for example using using a low temperature approach as described above with reference to method 1200. Binder 1446 can be thermally stable for its utility as a binder when heated to T_{g} of the Li-sulfide glass of which glassy medium 302 is composed, or slightly above T_{g}, or at temperatures slightly below T_{c}. For instance, the binder can be stable from room temperature up to at least temperatures approaching 200° C., or 250° C., or 300° C., or to 350° C., or even thermally stable when heated to 400° C. or greater than 400° C. Network layer 1410 can be made by casting/coating a slurry of the constituent particles (electroactive material, binder, and an electronically conductive diluent such as carbon fibers, not shown) onto current collector 1481. Electroactive particles (e.g., cathode active material particles) may be individually coated with protective nanofilm 1445 as illustrated. In various embodiments, preformed network 1410 is coated with conformal nanofilm 1445. Once nanofilm coated network 1410 has been formed, it may be embedded by glassy medium 302 using the methods described above in FIGS. 10-12, and in particular the low temperature approach described with reference to FIG. 12.

With reference to FIG. 14B there is illustrated embedded electrode assembly 1400B having a dual electroactive layer (e.g., a dual positive electroactive layer) 1410B composed of positive electroactive particles (e.g., NMC or LFP particles) and solid electrolyte particles, wherein the dual layer is composed of a first layer 1410B-1 and a second porous layer 1410B-2. In various embodiments layer 1410B-1 is substantially denser than layer 1410B-2. In various embodiments the solid electrolyte particles in the first and second layers have different solid electrolyte particles. For instance, the first layer 1410B-1 having phosphate or oxide Li ion conducting particles (e.g., LATP particles) that are chemically compatible in air, and devoid of particles that are chemically incompatible with ambient air (e.g., sulfide solid electrolytes), and the second layer is porous and composed of sulfide solid electrolyte particles that adhere strongly to glassy medium. In various embodiments the sulfide particles are themselves glassy and of the same or similar composition to that of the glass. In other embodiments the Li ion conducting sulfide particles of the second layer may be crystalline materials that can adhere to the glassy medium. For instance, the first layer, compatible in ambient air, may be fabricated onto a current collecting layer in an air environment. When fabricating the electrode assembly, and the cell thereafter, the as-fabricated first layer/current collector can be adhered to the second layer (e.g., via lamination), and then the glassy medium adhered onto the second layer. As such, the second layer can serve as a bonding mechanism for combining the first layer within the electrode assembly, and wherein most of the electrode capacity resides (e.g., greater than 70% of the ampere-hour capacity resides in the first layer). In other embodiments, the electroactive layer may be a single layer with a varied pore structure along its thickness direction. For instance, pores may be introduced using pore forming agents followed by their decomposition, or using a post processing step including laser ablation to create macropores within the second layer, and therein serving to receive sulfide glass particles that promote bonding of the electroactive layer when laminated to the glassy medium (e.g., with pressure and heat). When sulfide solid electrolytes are incorporated in the pores of the electroactive layer, ion etching may be used to remove contaminates prior to lamination, in order to improve adhesion with the glassy medium.

With reference to FIGS. 14C and 14D there is illustrated glassy enveloped electrode assemblies (1400C and 1400D) of the present disclosure wherein electroactive network layer 1410 is enveloped within glassy medium 1402. Not shown in various embodiments, the glassy medium can penetrate the pores of layer 1410. In other embodiments, the pores of the layer are not penetrated, or at least only partially or incidentally present in surface pores of the layer. With reference to FIG. 14C, electroactive layer 1410 is fully enveloped with its first major surface and side surfaces embedded within the glassy medium, as well as the side surfaces of the current collecting layer 1481. For instance, the current collecting surface can be level with the glassy surface. In this case the glassy medium (or glass layer) forms a cup and is in contact with both the apparent first major surface of the electroactive layer and its side surfaces. In other embodiments, as illustrated in FIG. 14D only the electroactive layer is encapsulated within the glassy medium, and the current collecting side surfaces are not fully encapsulated (e.g., partially), and in some embodiments, the current collecting side surfaces are not at all covered by the glassy medium (e.g., the current collector is above the glass surface). Assemblies 1400C and 1400D may be fabricated by bonding electroactive layer 1410 to Li ion conductive glass membrane 302 (e.g., a sulfide glass layer) serving as the glassy medium via hot pressing or hot-rolling at temperatures above Tg of the glassy medium. When incorporated in a solid-state battery cell, an encapsulated electroactive layer may be in compression.

In various embodiments coated electroactive network layer 1410 is composed of electroactive particles such as Li intercalation materials (e.g., LCO, NCA, NMC) combined with a binder material that is Li ion conductive and may be sufficiently pliable to also serve as a binder material for the layer (e.g., sulfide glass or Li ion conducting argyrodites). For instance, the conductive binders may be sulfide-based Li ion conducting materials such as the argyrodites (e.g., having general composition Li₆PS₅X, where X may be a halide such as Cl, Br or I). Examples of suitable argyrodites include Li₆PS₅Cl, Li₆PS₅Br, Li₆PS₅I, and the like such as those with varying stoichiometries in terms of mole ratio of the halides to sulfur (e.g., Li₆PS_{5-y}X_{1+y}. In various embodiments layer 1410 is formed as porous structure, and fine sulfide glass may be infiltrated into the pores and heated to form an interpenetrating glassy network within the layer, and a glassy top layer applied on the surface. Suitable techniques include those described above such as air brushing followed by joule heating to make the glassy embedded electrode assembly. While glassy embedded electrode assemblies of the present disclosure generally have an interpenetrating glassy medium within the confines of the layer, in some embodiments the interior pores are infiltrated with polycrystalline conductors, such as the argyrodites. For instance, a structure contemplated herein is layer 1410 formed as a substantially dense layer with an encapsulating Li ion conductive sulfide glassy surface layer wherein the pores are infiltrated with highly conductive argyrodite particles, which may be submicron and formed cryogenically as described above for glassy sulfide media. And while not strictly a glassy embedded layer in the sense that there may not be Li ion conductive glass material within the electroactive layer, the glassy surface layer can bond to the infiltrated argyrodite to allow for continuous conduction, and possibly low interfacial impedance. In yet other embodiments, the electroactive layer 1410 may include other ion conductive additives (e.g., solid electrolyte particles), such as Li ion conducting oxides and phosphates which have the advantage of being more compatible with ambient conditions, and having a higher oxidation potential. For instance, layer 1410 containing phosphate Li ion conducting particles, and devoid of sulfide glasses or sulfide based crystalline ion conductors.

In various embodiments, the solid electrolyte in the pores of the electroactive layer (e.g., the cathode or positive electroactive layer) can be either polycrystalline or glassy. In some embodiments the solid electrolyte particles are of the same or similar composition to that of the glassy medium, and in other embodiments the solid electrolyte particles have a different composition, or are of a different class of ion conductor. In some embodiments, the solid electrolyte particles in the pores of the electroactive layer are glass or polycrystalline material that is not directly compatible with Li metal, while the glassy medium, or at least the surface of the glassy medium, is compatible with Li metal. In a particular embodiment, the glassy medium may be based on Li₂S P₂S₅ and the pores of the electroactive layer are filled with Li₂S B₂S₃-based glass. In other embodiments, the pores of the electroactive layer may be filled with Li ion conductive polycrystalline oxides and/or phosphates (e.g., LATP). In various embodiments the crystalline solid electrolyte material in the pores of the cathode electroactive material layer, and/or that of the anode electroactive material is of the lithium argyrodite sulfide electrolyte type, as well as other types of soft sulfide electrolyte materials particularly suitable for use as a binder. As described above, the electroactive particles may be protected by a nano-film such as alumina or other oxide material film to prevent reduction by the solid electrolyte within the electroactive layer (e.g., when it is a sulfide-based Li ion conducting material). In other embodiments, improved stability can be achieved by utilizing oxide or phosphate solid electrolyte particles, which can mitigate the need for the nanofilm protection due to its stability against oxidation by positive electroactive material such as LCO and NMC. The use of phosphates, such as LATP particles, has the added benefit of air stability, which allows for the electroactive layer to be fabricated in air, as opposed to an anhydrous inert atmosphere.

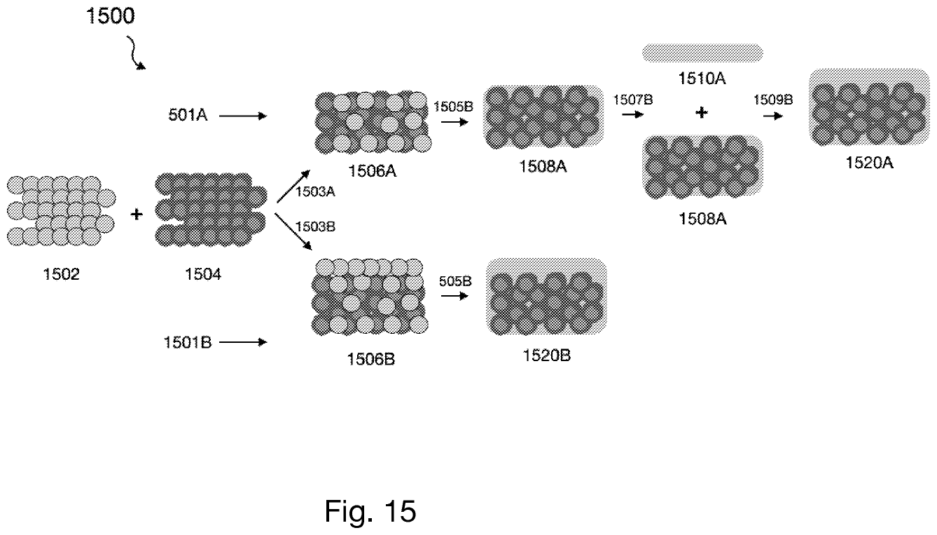

In yet other embodiments the electroactive network is not a discrete preformed body but a contiguous assemblage of electroactive particles that materializes in combination with glassy sulfide media as a result of forming a composite construct therefrom. For example, such a composite construct may be formed by pressing and heating (e.g., via hot isostatic pressing) a mixture of electroactive material particles and Li-sulfide glass particles to form the electroactive network and the continuous glassy medium, interpenetrating. In FIG. 15, a glassy embedded electrode assembly is illustrated wherein the electroactive network is not preformed, but rather formed in-situ along with glassy medium 302. Method 1500 involves providing Li-sulfide glass particles 1502 and nanofilm protected electroactive particles 1504, followed by mixing the particles and pressing to a compact. Compact 1506A is essentially a uniform compact mixture, whereas compact 1506B has a surface cover region of glass media particles above an otherwise substantially uniform bulk region. The compacts are then heated with pressure to form a glassy embedded electrode structure 1508A and 1520B, and in particular embodiments step 1505B involves hot isostatically pressing (HIP) the compacts. The encapsulating cover region may be formed by applying Li ion conducting glass sheet 1510A onto the surface of structure 1508A using heat and pressure, thus forming glassy embedded electrode assembly structure 1520A.

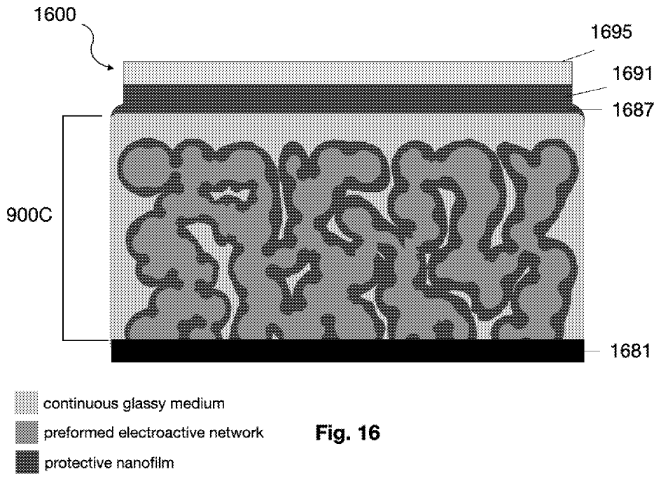

In FIG. 16 there is illustrated fully solid-state Li metal battery cell 1600 in accordance with the present disclosure. Cell 1600 includes glassy embedded positive electrode assembly 900 (as illustrated and described with reference to FIG. 9). Electrode assembly 900 first surface 100-1 includes protective surface layer 1687 (e.g., a tie layer, such as a metal wetting layer) that protects glassy medium surface 100-1 against adverse reaction from the external environment and is useful as a layer onto which Li metal layer 1691 may be deposited (e.g., by Li metal evaporation), and in some embodiments provides a layer to enhance uniform plating and striping of Li metal during battery charging/discharging. In various embodiments surface layer 1687 is a transient tie layer such as a metal film, semi-metal film, or some combination thereof, including a metal/semi-metal alloy or intermetallic film. For example, the transient tie layer may be an aluminum or indium or silver layer. In various embodiments the surface layer may be a Li ion conductive protective film that may be a glass or a conversion interlayer. For instance, a thin glass layer such as a lithium phosphorus oxynitride or a conversion layer of P₃N₅ that is converted to a Li ion conductive layer by applying Li metal to the surface of the conversion layer (e.g., forming one or more of a lithiated phosphorus nitride compound).

Al current collector 1681 is deposited on electrode assembly second surface 100-2 and Cu current collecting layer 1695 is deposited on Li metal layer 1691. In alternative embodiments the cell may be configured in an “anode free” configuration, wherein current collecting layer 1695 is deposited onto tie layer 1687. In anode free configuration the active anode material is lithium metal, and it is derived from the cathode in the as-fabricated cell and formed by plating lithium metal onto current collecting layer 1695. In some anode free configurations, a tie layer may be used as described above to facilitate uniform plating and striping. In this embodiment the electroactive network may be a partially sintered monolith of cathode active material of the intercalation type and lithiated (e.g., LCO, NCA, NMC, as well as sulfide and phosphate-based intercalation cathode active materials and the like).

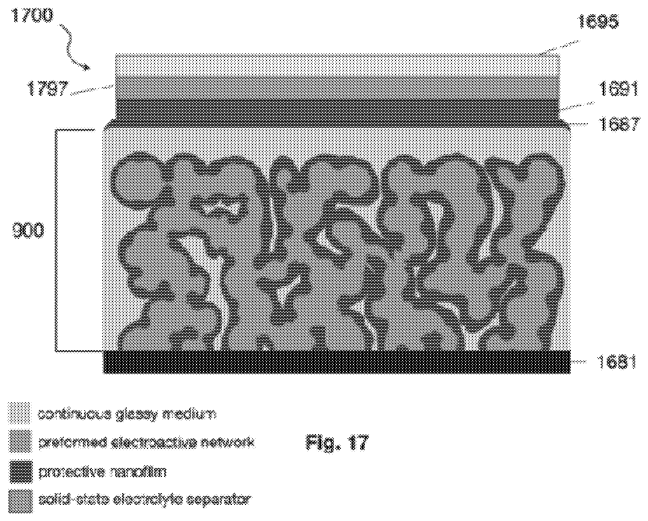

In FIG. 17 there is illustrated fully solid-state Li metal battery cell 1700 in accordance with the present disclosure. Cell 1700 includes solid-state electrolyte separator 1797 having first and second major opposing surfaces. The first surface of the solid-state separator in direct contact with electrode assembly 900, adjacent the glassy cover region and the second surface of the separator adjacent lithium metal layer 1695 in direct contact with the lithium metal layer. For instance, the solid-state electrolyte separator 1797 may be a sulfide glass layer, or an oxide lithium ion conducting layer such as a garnet layer or the like.

In other embodiments, the electrode assembly may not be made fully dense, and liquid or gel electrolyte may be impregnated into the voids to make a battery cell with a hybrid architecture, wherein liquid electrolyte contacts only one electrode (e.g., the positive electrode). Such a hybrid Li metal battery cell may include a glassy embedded positive electrode assembly that is a partially embedded structure with certain voids that are filled with a gel or liquid electrolyte. In a specific embodiment, the liquid phase electrolyte may be retained inside a solid polymer phase as a gel electrolyte. In various embodiments the method for making the hybrid electrode assembly includes impregnating the glassy embedded electrode assembly structure with a liquid phase comprising a liquid electrolyte and a light or thermally polymerizable monomer that is activated for polymerization after it has been impregnated into the pores of the electroactive network.

In various embodiments the electrode assembly is an inorganic-organic hybrid solid-state electrode having a composite material structure composed of a continuous inorganic electroactive material structure in the form of an inorganic three-dimensional porous electroactive network/scaffold and an organic based active metal ion conductive component disposed inside the porous scaffold, the organic component composed of an organic active metal ion conducting material (e.g., a Li ion conductive polymer).

For instance, the present disclosure provides an inorganic-organic hybrid solid-state electrode having a composite material structure composed of a continuous inorganic electroactive material structure in the form of an inorganic three-dimensional porous electroactive scaffold and an organic based active metal ion conductive component disposed inside (e.g., within the pores of, including in at least some embodiments filling the pores of) the porous scaffold, the organic component composed of an organic active metal ion conducting material (e.g., a Li ion conductive polymer). In various embodiments the inorganic three-dimensional porous electroactive scaffold is composed of cathode active material, and in a particular embodiment the porous electroactive scaffold is a partially sintered construct of cathode active material (e.g., lithiated or non-lithiated cathode active material) as described herein. Suitable scaffold materials can include, for example, partially sintered transition metal oxides and phosphates such as lithium cobalt oxide, lithium nickel cobalt oxide, lithium manganese cobalt oxide, and lithium iron phosphate materials, as well as non-lithiated transmission metal oxides and phosphates. In accordance with various embodiments, a partially sintered construct serves as the electroactive scaffold into which the organic Li ion conductive component is incorporated. By using the term scaffold to describe the porous electroactive component it is not meant to infer a particular void volume or pore structure. Generally, the scaffold can have a void volume of less than 90% and greater than 2%. For instance, a void volume between 5 to 40% (e.g., about 10%, or about 15% or about 20%, or about 25%, or about 30%, or about 35%).

In various embodiments, the architecture of the void volume (i.e., the pore structure) can be engineered depending on the use application of a battery in which the solid-state electrode is employed, for example. For instance, in various embodiments the pore structure may be engineered to incorporate channels into the depth of the scaffold to facilitate Li ion transport therethrough. In various embodiments, the channels may be through channels, that is channels that penetrate the full thickness of the inorganic scaffold, for example vertical or substantially vertical through channels). In certain embodiments, the channels can be engineered, in part, to reduce or minimize void volume, and thus increases or maximize or optimize the amount of active material per unit volume of electrode, and thereby improve the energy density of the battery cell (e.g., a solid-state battery cell). Partially sintered cathode active material constructs and glassy embedded solid electrode assemblies suitable for adaptation in accordance with this disclosure are described in U.S. Patent Publication No. US 2022-0045328, which is hereby incorporated by reference herein for that description.

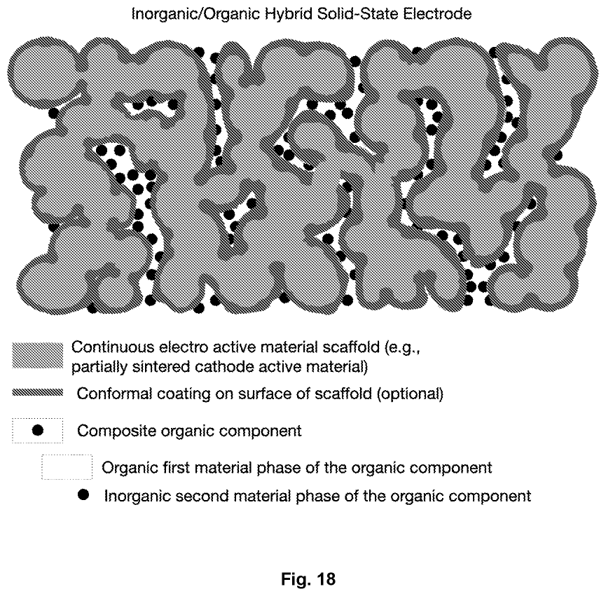

In various embodiments the present disclosure provides an inorganic-organic hybrid solid-state electrode having a composite material structure composed of a continuous inorganic electroactive material structure in the form of an inorganic three-dimensional porous electroactive scaffold and an organic based active metal ion conductive component disposed inside the porous scaffold, the organic component composed of an organic active metal ion conducting material (e.g., a Li ion conductive polymer), an sample embodiment of which is illustrated in FIG. 18. The Li ion conductivity of the organic material component should be sufficiently conductive to facilitate Li ion transport when the electrode of the present disclosure is employed in a battery cell. Suitable Li ion conductivity of the organic material component may be at least 10⁻⁴ S/cm at about 40° C. or at room temperature (about 23° C.); or at least 5×10⁻⁴ S/cm at about 40° C. or at room temperature (about 23° C.); or at least 10⁻³ S/cm at about 40° C. or at room temperature (about 23° C.). In accordance with aspects of the present disclosure the Li ion conductive organic component is referred to herein as an organic component because it includes as a material of the component an organic Li ion conductor, such as a polymer electrolyte. Accordingly, in various embodiments the organic component is not wholly organic but rather an organic/inorganic composite such as that which is composed of a first material phase that is an organic Li ion conducting material (e.g., a Li ion conductive polymer electrolyte) and a second material phase that is an inorganic Li ion conducting material (e.g., a sulfide, oxide or phosphate Li ion conducting material), typically the inorganic material may be in the form of small particles dispersed throughout the organic material phase, as illustrated, for example, in FIG. 1. In other embodiments, the organic component may be substantially composed of an organic Li ion conducting material, such as a polymer electrolyte having a lithium salt dissolved therein. In various embodiments the conductivity of the polymer electrolyte is at least 10⁻⁵ S/cm at about 40° C. or at room temperature (about 23° C.); or at least 10⁻⁴ S/cm at about 40° C. or at room temperature (about 23° C.). When the organic component is an organic/inorganic composite, the inorganic material phase (e.g., inorganic material particles) may suitably have a Li ion conductivity of at least 104 S/cm at about 40° C. or 10⁻⁴ S/cm at room temperature (about 23° C.); or at least 10⁻³ S/cm at about 40° C. or 10⁻³ S/cm at room temperature (about 23° C.).

In various embodiments the organic polymer electrolyte component has poor Li ion conductivity relative to the Li ion conductivity of inorganic particles dispersed within it. For instance, the Li ion conductivity of the polymer electrolyte may be about two orders of magnitude lower than the conductivity of the dispersed inorganic particles, or about three orders of magnitude, or even about 4 orders of magnitude, or more, lower than the conductivity of the dispersed inorganic particles. In various embodiments the Li ion conductivity of the polymer electrolyte is about or less than two orders of magnitude lower than the conductivity of the dispersed inorganic particles.

In various embodiments the polymer electrolyte is an amorphous or substantially amorphous material. For instance, an oxyethylene-oxymethylene copolymer (e.g., poly[oxymethylene-oligo(oxyethylene), such as those which are known to have a similar molecular structure to poly(ethylene oxide) and having dissolved therein a Li salt, such as those which are known in the art and including LiClO₄, LiTFSI (lithium bis(-trifluoromethanesulfonyl) imide, and LiPF₆). Such amorphous polymer electrolytes are described by Linden and Owen in Solid State Ionics 28-30 (1988) 994-1000, and titled Conductivity Measurements on Amorphous PEO Copolymers, as well as by Booth et. al. in Journal Article J. Mater. Chem, 1996 6(7), 1099-1106 titled Poly[oxymethylene-oligo (oxyethylene) network electrolytes, and by Booth et. al. in Journal Article J. Mater. Chem., 1995, 5(6), 831-836 and titled High-molar-mass Branched Poly[oxymethylene-oligo(oxyethylene) for use in Polymer Electrolytes, all of which are incorporated herein by reference. In various embodiments the polymer electrolyte is a Jeffamine™-based polymer, such as described in Journal of Power Sources 347 (2017) 37-46. In various embodiments the polymer electrolyte may be composed of a comb matrix having polyether moieties and a Li salt, such as described in the Journal of Power Sources 383 (2018) 144-149. In various embodiments, the polymer electrolyte has a Li ion conductivity at room temperature that is greater than 10⁻⁵ S/cm, or greater than 10⁻⁴ S/cm, or greater than 10⁻³ S/cm.

As noted above, in various embodiments the organic component is not wholly organic but rather an organic/inorganic composite such as that which is composed of a first material phase that is an organic Li ion conducting material (e.g., a Li ion conductive polymer electrolyte, as described above) and a second material phase that is an inorganic Li ion conducting material (e.g., a sulfide, oxide or phosphate Li ion conducting material), typically the inorganic material in the form of particles dispersed throughout the organic material phase. In various embodiments the second material phase (e.g., small inorganic particles) is an inorganic Li ion conducting sulfide material such as Li ion conducting sulfide glasses as described in U.S. Pat. No. 10,164,289 (incorporated by reference herein for the purpose of this description), thio-LISICON (e.g., Li_{3.25}Ge_{0.25}P_{0.75}S₄), Li₃PS₄ and other polysulfide phosphates, crystalline lithium sulfide Li ion conductors such as Li₇P₃S₁₁, Li₁₀XP₂S₁₂ (where X may be Ge, Sn, Si) and lithium argyrodites (e.g., Li₆PS₅X, where X may be Cl, Br, I). For example, the second material phase may be argyrodite particles. In other embodiments the inorganic second material phase may be particles of the garnet type, e.g., such as those related to Li₇La₃Zr₂O₁₂ (LLZO) or Li_{6.75}La₃Zr_{1.75}Ta_{0.25}O₁₂ (LLZTO), or anti-perovskites or lithium metal phosphates such as those having a NASICON type structure, such as lithium titanium phosphates (e.g., LTP), lithium aluminum titanium phosphates (LATP), lithium germanium phosphates (LGP), such as Li₁₊ₓ3zAlₓ(Ti,Ge)₂₋ₓSi_{3z}P_{3-z}O₁₂.

In various embodiments the relative particle loading of the inorganic second material phase particles (e.g., argyrodite particles or LATP particles, for example) relative to that of the polymer electrolyte can be engineered to achieve sufficient Li ion conductivity throughout the organic component for the desired application and to ensure that the organic component is disposed throughout the pore structure of the scaffold, including both large, small and very small pores and channels, and to ensure that the organic component is capable of forming a Li ion transparent interface with the inorganic electroactive material scaffold.

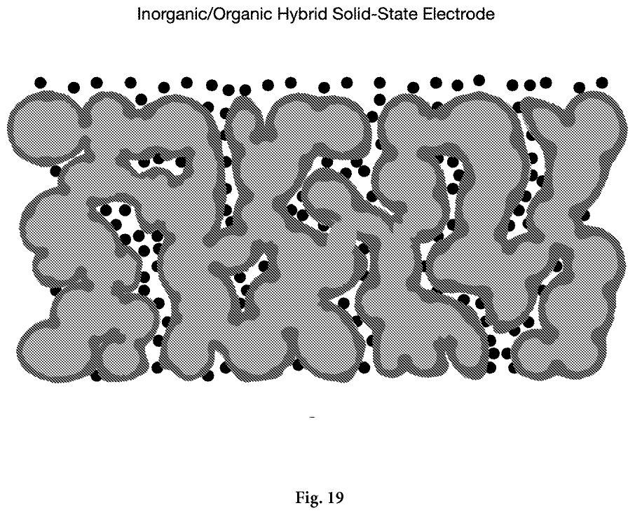

As illustrated in FIG. 19, in various embodiments the inorganic-organic hybrid solid-state electrode has a first major surface defined by the organic component (e.g., a composite organic component, as illustrated). In other embodiments (not shown), the inorganic-organic hybrid solid-state electrode may have a major surface defined by the inorganic component.

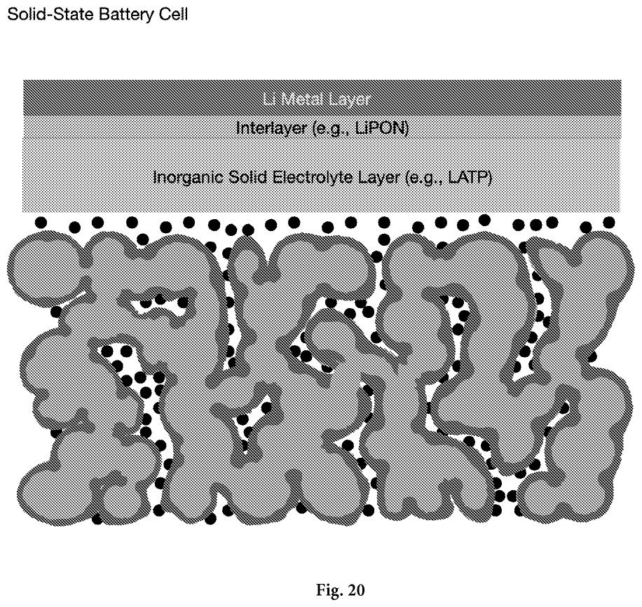

With reference to FIG. 20 there is illustrated a solid-state battery cell in accordance with an embodiment of the present disclosure. The battery cell incorporating an inorganic-organic hybrid solid-state electrode. In various embodiments the battery cell of the present disclosure is fully solid-state. In various embodiments the battery cell is a lithium metal battery cell, wherein the inorganic-organic hybrid solid-state electrode of the present disclosure is composed of inorganic cathode active material and serves as a positive electrode, and the negative electrode is based on lithium metal as the anode active material of the negative electrode, such as in the form of a lithium metal layer. In various embodiments, the battery cell of the present disclosure further comprises a solid-state electrolyte layer component disposed between the positive and negative electrode, such as is illustrated in FIG. 20.

In particular embodiments, the solid-state electrolyte layer component is wholly inorganic, substantially dense and pinhole free, and has a first major surface opposing the lithium metal layer that is chemically compatible in direct contact with the lithium metal layer. In various embodiments the solid-state electrolyte layer component is composed of a solid electrolyte layer (e.g., a sheet) that is not inherently chemically compatible in contact with lithium metal, and the first major surface of the solid electrolyte layer component is defined by a material film on the surface of the solid electrolyte layer that serves as chemically compatible interlayer therebetween (e.g., an ALD layer of LiPON). In various embodiments, the solid electrolyte layer is air stable, and in particular embodiments thereof composed of LATP. In various embodiments the interlayer is a dual layer or formed as dual layer, for instance, a dual LiPON layer wherein a first substituent layer is formed by ALD with a composition composed of lithium phosphorus oxygen and nitrogen, and the second substituent layer is LiPON formed by puttering. In various embodiments, the first and second substituent layers of the dual layer are differentiable based on composition and/or morphology of the substituent layers.

In various embodiments according to this aspect of the disclosure, a solid-state electrode structure may be composed of an alkali metal ion conducting solid electrolyte layer having a conformal nano-film covering a first surface of the solid electrolyte layer, the nano-film stabilizing the solid electrolyte first surface for contact with a Li metal layer. In various embodiments, the composition of the solid electrolyte layer and that of the conformal nano-film are compositionally and structurally different. In various embodiments the solid electrolyte layer is freestanding or substrate-less. In various embodiments, the solid electrolyte layer is chemically compatible with moisture. In various embodiments, the conformal nano-film may be deposited onto the solid electrolyte first surface using atomic layer deposition (ALD). In various embodiments, the ALD process is an aqueous process, and the water stability of the solid electrolyte layer in this process is an important feature that enables a robust and conformal nanofilm, for example with no pinholes or cracks. In various embodiments, it is contemplated that the conformal nanofilm is sufficiently robust to serve as an interlayer between the solid electrolyte layer and a Li metal layer in direct contact with the nanofilm. In a particular embodiment, the solid electrolyte layer may be a Li ion conducting metal phosphate. The metal phosphate may be water stable. Suitable water stable Li ion conducting metal phosphates include lithium titanium/germanium phosphates, lithium titanium/germanium aluminum phosphates. A suitable metal phosphate in some embodiments may be an oxide/phosphate of a lithium titanium phosphate, such as LATP having stoichiometry Li₁₊ₓAlₓTi₂₋ₓ(PO₄)₃ or perovskite and the like. In other embodiments, the oxide electrolyte may be a garnet layer (e.g., LLZO) as is known in the battery arts, for example Li₇La₃Zr₂O₁₂. A suitable thickness of the solid electrolyte layer in some embodiments can be less than 100 μm thick, or not greater than 50 μm thick, or not greater than 30 μm thick, or not greater than 20 μm thick, or not greater than 15 μm or 10 μm thick.

In various embodiments, the conformal nano-film composition may be lithiated, and composed of lithium oxygen and phosphorus (e.g., a lithium phosphate) and may further include nitrogen as a constituent element of the nano-film, such as a lithium phospho-nitride (e.g., LiPON or the like). In some embodiments, nano-film thickness is generally about 1 to 50 nm, and more typically about 2 to 20 nm. In alternative embodiments, non-lithiated conformal nanofilms are also contemplated herein (e.g., alumina and the like). In alternative embodiments, other compositions are contemplated for a suitable nano-film, including lithium metal oxides Li₂SiO₃, Li₄Ti₅O₁₂, LiTaO₃, LiAlO₂, Li₂O—ZrO₂, Li₂ZrO₃, Li₂TiO₃, LiNbO₃, and metal oxides, such as Al₂O₃, TiO₂, ZrO₂, V₂O₅. Also contemplated are metal phosphates (e.g., manganese phosphate, cobalt phosphate, iron phosphate, and titanium phosphate, metal fluorides (e.g., aluminum fluoride, lithium aluminum fluoride, iron fluoride, and the like), metal oxyfluorides, and metal hydroxides.

In various embodiments, the solid-state electrode structure may also include additional layer(s) that serves as interlayer(s) between the conformal nano-film and the Li metal layer. In various embodiments, the solid-state electrode structure includes a single interlayer. In a particular embodiment, the interlayer is compositionally similar to that of the conformal nano-film. In suitable examples, the conformal nano-film may be composed of Li, P, O, and N as constituent elements, and likewise the interlayer (e.g., both the conformal nano-film and the interlayer are LiPON or LiPON like). In various embodiments, the nano-film may be generally deposited directly onto the solid electrolyte layer using a conformal vapor deposition approach, such as atomic layer deposition, while the interlayer is deposited using a different approach, which may create a different morphology that delineates an interface between the nano-film and the interlayer. Accordingly, in various embodiments the conformal nano-film and the interlayer are distinct, amorphous atomic structures.

In various embodiments, the interlayer can also be chemically compatible with moisture. In various embodiments, the interlayer can be a conversion compound of a metal nitride material or a metal phosphide material (e.g., copper nitride, aluminum nitride, tin nitride, and the like). By use of the term conversion compound interlayer, it is meant that the interlayer reacts with the Li metal layer of the structure to form a composite material layer (e.g., composed of the metal of the nitride and lithium nitride). Conversion compound interlayers are described in U.S. Pat. No. 7,432,017, for example, which is hereby incorporated by reference for its disclosure in this regard. For instance, in various embodiments, a Li metal layer of a solid-state electrode structure can be deposited onto the interlayer using a physical vapor deposition technique, such as thermal evaporation or pulsed laser deposition. The deposition of the Li metal layer leads to the conversion of the interlayer into a composite layer to form a conversion compound interlayer. In various embodiments, the interlayer is sufficiently thick and provides sufficient coverage over the conformal nano-film to enable high-rate deposition of Li metal without damaging the conformal nano-film.

In various embodiments, the solid electrolyte layer can be a polycrystalline material that is manufactured in the form of a freestanding or substrate-less precursor glass sheet. The glass sheet, once formed, can be converted to a ceramic (or glass ceramic) having a controlled surface roughness. In various embodiments, the process of converting the substrate-less solid electrolyte glass layer to a substrate-less ceramic layer (“ceraming”) can be performed in a manner that minimizes the surface roughness of the as-produced polycrystalline ceramic layer while maintaining high Li ion conductivity and handleability of the layer. Methods for making the precursor glass sheet include such methods as are known in the glass making arts, including drawing, extrusion, blowing, pressing, and float.

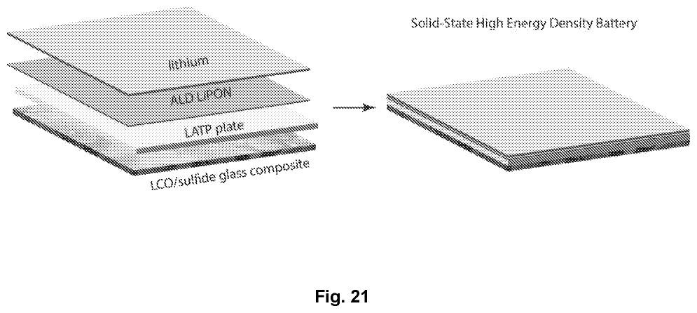

With reference to FIG. 21, there is illustrated an embodiment of the present disclosure. In various embodiments, the solid electrolyte structure may further include an interlayer, as described above, disposed between a conformal ALD LiPON layer and a lithium metal layer. The solid-state electrode structure may be combined with a cathode/positive electrode for making a battery cell. As illustrated in FIG. 1, in various embodiments the cathode may be solid-state and the battery also fully solid-state. In other embodiments, it is contemplated that the positive electrode may also include a liquid or gel electrolyte. For a solid-state embodiment, the positive electrode may use a porous transition metal oxide (e.g., lithium cobalt oxide) as the active material layer and Li ion conducting sulfide material (e.g., sulfide glass) incorporated inside the pores to provide ionic pathways for conduction of Li ions into the depth of the positive electrode. Suitable solid-state electrode structures are described, for example, in U.S. Patent Publication No.: 2022/0045328, which is hereby incorporated by reference for its disclosure in this regard. In embodiments having an interlayer disposed between the ALD LiPON layer and the Li metal layer, the interlayer may also be composed of LiPON (e.g., sputtered or deposited by pulse laser deposition). In various embodiments the interlayer may be a conversion metal nitride, as described above.

In other embodiments the solid electrolyte separator layer may be a glass or glass ceramic or full ceramic of the garnet type that is fabricated initially as a glass sheet. In various embodiments the glass may be processed from a Ta doped Li₇La₃Zr₂O₁₂ material using glass forming dopants (e.g., by melt quenching and then drawing the glass into the ribbon). The ribbon so formed may be used as a dense solid electrolyte layer if sufficiently conductive, or otherwise heat treated to crystallize a more conductive phase. Glass forming additives may include oxides (e.g., tantalum oxide, or germanium oxide, or gallium oxide, or lanthanum oxide, or silicon oxide, or boron oxide, or chromium oxide, or indium oxide, or bismuth oxide, or vanadium oxide, or phosphorus oxide). For instance, in a particular embodiment the composition of the melt may be composed of lithium, lanthanum, zirconium and oxygen, and tantalum oxide may be the glass forming additive. Moreover, various percentages of glass/crystalline wt. % are contemplated, including about 95% crystalline and 5% glassy, or about 90% crystalline and 10% glassy, or about 80% crystalline and 20% glassy, or about 70% crystalline and 30% glassy, or about 60% crystalline and 40% glassy, or about 50% crystalline and about 50% glassy.

In some embodiments the dense layer is an oxide/phosphate such as lithium titanium phosphate (LATP) or the like having a thin interlayer/film disposed between it and the lithium metal. For instance, the LATP having a thin film of a garnet-like material deposited on its surface. In a particular embodiment the interlayer film may be an amorphous oxide layer that is formed by physical/chemical vapor deposition (e.g., sputtering or the like), wherein the sputtering target has composition Li_{7+x-y}AₓB₃₋ₓC_{2-y}D_{y}O₁₂ wherein A is a bivalent cation, B is a trivalent cation, C is a tetravalent cation, and D a pentavalent cation, with 0≤x<3 (e.g., 0≤x≤2 or 0≤x<1). In particular embodiments the target is a Ta doped LLZO. The surface film so formed may be amorphous with Li ion conductivity of at least 10⁻⁷ S/cm, or at least 10⁻⁶ S/cm, or at least 10⁻⁵ S/cm. In accordance with the present disclosure the nature of the surface film is sufficiently robust that it protects grain boundaries of the bulk membrane (e.g., that of the LATP) and thereby allows for reversible cycling of lithium metal. In other embodiments the bulk membrane may be composed of a similar or the same family as the amorphous layer. For instance, the sputtering target and the membrane have a bulk composition Li_{7+x-y}AₓB₃₋ₓC_{2-y}D_{y}O₁₂ wherein A is a bivalent cation, B is a trivalent cation, C is a tetravalent cation, and D a pentavalent cation, with 0≤x<3 (e.g., 0≤x≤2, or 0≤x<1). The sputtering target and membrane bulk may have substantially the same composition, or different. It is also contemplated that the bulk membrane may be a lithium ion conducting sulfide material and in particular lithium ion conducting sulfide glass as described herein and in U.S. Pat. No. 10,164,289.

### CONCLUSION

Although the foregoing disclosure has been described in some detail for purposes of clarity of understanding, it will be apparent that certain changes and modifications may be practiced within the scope of the appended claims. It should be noted that there are many alternative ways of implementing both the process and compositions of the present disclosure. Accordingly, the present embodiments are to be considered as illustrative and not restrictive, and the disclosure is not to be limited to the details given herein.

All references cited herein are incorporated by reference for all purposes.

What is claimed is:

1. A solid-state battery comprising, an enveloped electrode assembly comprising an electroactive layer having a first major surface and side surfaces encapsulated within a Li ion conductive glassy medium.

2. The solid-state battery of claim 1, wherein, the electroactive layer is in compression.

3. The solid-state battery of claim 1, wherein the electroactive layer further comprises a current collecting layer having a first surface that is covered by the electroactive layer, a second surface that is exposed, and side edges, and wherein the glassy medium encapsulates the side edges of the current collector but not the second surface.

4. The fully solid-state battery of claim 1, wherein the electroactive layer comprises polycrystalline solid electrolyte particles having a phosphate composition.

5. The fully solid-state battery cell of claim 4, wherein the electroactive layer has a dual layer structure, wherein a first layer provides a majority of the electroactive layer ampere-hour capacity and comprises the phosphate polycrystalline solid electrolyte particles, and a second porous layer in direct contact with the glassy medium, wherein the pores of the second layer contain Li ion conducting sulfide solid electrolyte.

6. The fully solid-state battery of claim 5, wherein the phosphate electrolyte particles are LATP and the sulfide solid electrolyte is a glass.
